(19) United States
(12) Patent Application Publication
(10) Pub. No.: US 2025/0126063 A1
(43) Pub. Date: Apr. 17, 2025

(54) RELAY APPARATUS, COMMUNICATION SYSTEM, AND COMMUNICATION CONTROL METHOD

(71) Applicant: NEC Corporation, Tokyo (JP)

(72) Inventor: Takahiro FUJISAKU, Tokyo (JP)

(73) Assignee: NEC Corporation, Tokyo (JP)

(21) Appl. No.: 18/903,133

(22) Filed: Oct. 1, 2024

(30) Foreign Application Priority Data
Oct. 13, 2023 (JP) 2023-177675

(51) Int. Cl. H04L 47/12; H04L 12/46; H04L 12/66

(52) U.S. Cl. CPC H04L 47/12; H04L 12/46; H04L 12/66

(57) ABSTRACT

A relay apparatus includes: a reception part recording a reception time of the data packet at the relay apparatus in the data packet; a packet buffer part storing the data packet; an upstream-side communication time calculation part calculating an upstream-side communication time by subtracting a transmission time at the transmission apparatus from the reception time at the relay apparatus; a downstream-side communication time calculation part calculating a downstream-side communication time based on a downstream-side communication time function and a capacity value; a timer part counting a retention time of the data packet; a deadline management part calculating a deadline of the data packet based on the upstream-side communication time, the downstream-side communication time, and the retention time; and a transmission part transmitting with a highest priority a data packet corresponding to a minimum value of a deadline among data packets stored.

### FIELD

### Reference to Related Application

The present invention is based upon and claims the benefit of the priority of Japanese patent application No. 2023-177675, filed on Oct. 13, 2023, the disclosure of which is incorporated herein in its entirety by reference thereto.

The present invention relates to a relay apparatus, a communication system, and a communication control method.

### BACKGROUND

Relay apparatuses such as switching hubs, routers, and repeaters receive various types of packets. General relay apparatuses adopt the best-effort method in which packets are outputted (transmitted) in the order in which they are inputted (received). However, in the best-effort method, for example, if an audio data packet is inputted to a relay apparatus after a video data packet, the audio data packet is outputted after the video data packet, and the audio data packet is consequently delayed. As a result, an audio lag could be caused.

To address the problem of the best-effort method, there is a priority assignment method in which packets are each assigned a priority in advance and are outputted in descending order of the priority in a relay apparatus. However, the priority assignment method has a problem in that, if high-priority packets in the relay apparatus are inputted one after another before low-priority packets are outputted, the output of the low-priority packets is delayed significantly due to congestion.

To address the problem of the priority assignment method, there is a priority change method that lowers the priority of packets outputted from a relay apparatus when the measured communication volume of the packets inputted to the relay apparatus exceeds a predetermined value set in advance (see, for example, Patent Literature 1).
PTL 1: Japanese Unexamined Patent Kokai-Publication No. 2003-188913 A

### SUMMARY

The following analysis has been given by the inventor of the present application.

However, the priority change method does not take the retention time and the communication time of the individual packet inside and outside the relay apparatus into account. Thus, in some cases, packets could still remain in the relay apparatus for a long time before output. That is, the priority change method has a problem in that packets cannot be reliably communicated within an appropriate time (deadline).

It is a main object of the present invention to provide a relay apparatus, a communication system, and a communication control method that can accurately control the communication of individual packets within an appropriate time (deadline) by executing a packet relay process in view of the retention time and the communication time of the packets inside and outside the relay apparatus.

a According to a first aspect, there is provided relay apparatus configured to relay a data packet from a transmission apparatus to a reception apparatus, the relay apparatus including:
a time synchronization part configured to synchronize a time of the relay apparatus with a time of the transmission apparatus and a time of the reception apparatus;
a reception part configured to receive the data packet from the transmission apparatus and to record a reception time of the data packet at the relay apparatus in the data packet based on the time synchronized by the time synchronization part;
a packet buffer part configured to store the data packet from the reception part;
an upstream-side communication time calculation part configured to calculate an upstream-side communication time from the transmission apparatus to the relay apparatus by subtracting a transmission time of the data packet at the transmission apparatus from the reception time recorded in the data packet, the transmission time being included in the data packet stored in the packet buffer part;
a downstream-side communication time calculation part configured to calculate a downstream-side communication time from the relay apparatus to the reception apparatus, based o n a downstream-side communication time function for calculating a downstream-side communication time from the relay apparatus to the reception apparatus and a capacity value included in the data packet stored in the packet buffer part, the downstream-side communication time function being a packet capacity value as a variable;
a timer part configured to count a retention time of the data packet in the packet buffer part, the data packet being stored in the packet buffer part;
a deadline management part configured to calculate a deadline of the data packet stored in the packet buffer part by subtracting, from an initial deadline included in the data packet stored in the packet buffer part, the upstream-side communication time calculated by the upstream-side communication time calculation part, the downstream-side communication time calculated by the downstream-side communication time calculation part, and the retention time counted by the timer part; and a transmission part configured to transmit, with a highest priority, a data packet corresponding to a minimum value of the deadline calculated by the deadline management part among data packets stored in the packet buffer part to the reception apparatus.

According to a second aspect, there is provide a communication system including:
at least one of the relay apparatuses according to the first aspect;
at least one of the transmission apparatuses configured to generate and transmit the data packet to the relay apparatus; and
the reception apparatus configured to receive the data packet from the transmission apparatus via the relay apparatus and to store the data packet.

According to a third aspect, there is provided a communication control method that controls communication by a relay apparatus that relays a data packet from a transmission apparatus to a reception apparatus, and the communication control method includes:
a step of synchronizing a time of the relay apparatus with a time of the transmission apparatus and a time of the reception apparatus;
a step of receiving the data packet from the transmission apparatus and recording a reception time of the data packet at the relay apparatus in the data packet based on the time synchronized;
a step of storing the data packet in which the reception time has been recorded;
a step of calculating an upstream-side communication time from the transmission apparatus to the relay apparatus by subtracting a transmission time of the data packet at the transmission apparatus from the reception time recorded in the data packet, the transmission time being included in the data packet stored;
a step of calculating a downstream-side communication time from the relay apparatus to the reception apparatus, based on a downstream-side communication time function for calculating a downstream-side communication time from the relay apparatus to the reception apparatus and a capacity value included in the data packet stored, the downstream-side communication time function being a packet capacity value as a variable a step of counting a retention time of the data packet stored;
a step of calculating a deadline of the data packet stored by subtracting, from an initial deadline included in the data packet stored, the upstream-side communication time calculated, the downstream-side communication time calculated, and the retention time counted; and a step of transmitting, with a highest priority, a data packet corresponding to a minimum value of the deadline calculated among data packets stored, to the reception apparatus.

According to a fourth aspect, there is provided a program executed by a relay apparatus that relays a data packet from a transmission apparatus to a reception apparatus, and causes the relay apparatus to execute: a process for synchronizing a time of the relay apparatus with a time of the transmission apparatus and a time of the reception apparatus;
a process for receiving the data packet from the transmission apparatus and recording a reception time of the data packet at the relay apparatus in the data packet based on the time synchronized;
a process for storing the data packet in which the reception time has been recorded;
a process for calculating an upstream-side communication time from the transmission apparatus to the relay apparatus by subtracting a transmission time of the data packet at the transmission apparatus from the reception time recorded in the data packet, the transmission time being included in the data packet stored;
a process for calculating a downstream-side communication time from the relay apparatus to the reception apparatus, based on downstream-side communication time function for calculating a downstream-side communication time from the relay apparatus to the reception apparatus and a capacity value included in the data packet stored, the downstream-side communication time function being a packet capacity value as a variable
a process for counting a retention time of the data packet stored;
a process for calculating a deadline of the data packet stored by subtracting, from an initial deadline included in the data packet stored, the upstream-side communication time calculated, the downstream-side communication time calculated, and the retention time counted; and
a process for transmitting, with a highest priority, a data packet corresponding to a minimum value of the deadline calculated among data packets stored, to the reception apparatus.

The program can be recorded in a computer-readable storage medium. The storage medium may be a non-transient storage medium such as a semiconductor memory, a hard disk, a magnetic recording medium, or an optical recording medium. In the present disclosure, the program can be embodied as a computer program product. The program can be inputted to a computer apparatus via an input device or a communication interface from the outside, can be stored in a storage device, can cause a processor to drive in accordance with predetermined steps or a predetermined process, can display processing results including intermediate states as needed via a display device in each phase, or can communicate with an external node via a communication interface. For example, the computer apparatus for this purpose includes a processor, a storage device, an input device, a communication interface, and as needed, a display device, which can typically be connected to each other via a bus.

According to any one of the first to fourth aspects, it is possible to accurately control the communication of individual packets within an appropriate time (deadline) by executing a packet relay process in view of the retention time and the communication time of the packets inside and outside a relay apparatus.

### BRIEF DESCRIPTION OF DRAWINGS

FIG. 1 is a block diagram schematically illustrating a first example of a configuration of a communication system according to the present disclosure.

FIG. 2 is a schematic diagram illustrating an example of a configuration of a data packet when the data packet is stored in a reception apparatus in the first example of the configuration of the communication system according to the present disclosure.

FIG. 3 is a schematic diagram illustrating an example of a configuration of a downstream-side communication information packet in the first example of the configuration of the communication system according to the present disclosure.

FIG. 4 is a schematic diagram illustrating an example of calculation of an upstream-side communication time by a relay apparatus in the first example of the configuration of the communication system according to the present disclosure.

FIG. 5 is a schematic diagram illustrating an example of a downstream-side communication time function used by the relay apparatus in the first example of the configuration of the communication system according to the present disclosure.

FIG. 6 is a schematic diagram illustrating an example of calculation of a downstream-side communication time by the relay apparatus in the first example of the configuration of the communication system according to the present disclosure.

FIG. 7 is a schematic diagram illustrating an example of the state of a packet buffer part and a deadline management part when a timer part is reset in the relay apparatus in the first example of the configuration of the communication system according to the present disclosure.

FIG. 8 is a schematic diagram illustrating an example of the state of the timer part, the packet buffer part, and the deadline management part when the relay apparatus in the first example of the configuration of the communication system according to the present disclosure transmits a packet A after the state in FIG. 7.

FIG. 9 is a schematic diagram illustrating an example of the state of the timer part, the packet buffer part, and the deadline management part immediately before the relay apparatus in the first example of the configuration of the communication system according to the present disclosure receives a packet D after the state in FIG. 8.

FIG. 10 is a schematic diagram illustrating an example of the state of the packet buffer part and the deadline management part when the relay apparatus in the first example of the configuration of the communication system according to the present disclosure receives the packet D and the timer part is reset after the state in FIG. 9.

FIG. 11 is a flowchart schematically illustrating an operation relating to a packet reception process of the relay apparatus in the first example of the configuration of the communication system according to the present disclosure.

FIG. 12 is a flowchart schematically illustrating a n operation relating to a packet transmission process of the relay apparatus in the first example of the configuration of the communication system according to the present disclosure.

FIG. 13 is a block diagram schematically illustrating a the second example of the configuration of communication system according to the present disclosure.

FIG. 14 is a schematic diagram illustrating an example of a configuration of a data packet when the data packet is stored in a reception apparatus in the second example of the configuration of the communication system according to the present disclosure.

FIG. 15 is a schematic diagram illustrating an example of a configuration of a downstream-side communication information packet in the second example of the configuration of the communication system according to the present disclosure.

FIG. 16 is a schematic diagram illustrating an example of a configuration of an abnormality notification packet in the second example of the configuration of the communication system according to the present disclosure.

FIG. 17 is a schematic diagram illustrating an example of calculation of an upstream-side communication time and a downstream-side communication time when there is no abnormality notification of each relay apparatus in a modification example of the second example of the configuration of the communication system according to the present disclosure.

FIG. 18 is a schematic diagram illustrating an example of calculation of an upstream-side communication time and a downstream-side communication time when there is one abnormality notification of each relay apparatus according to a modification example of the second example of the configuration of the communication system according to the present disclosure.

FIG. 19 is a schematic diagram illustrating an example of calculation of an upstream-side communication time and a downstream-side communication time when there are two abnormality notifications of each relay apparatus according to a modification example of the second example of the configuration of the communication system according to the present disclosure.

FIG. 20 is a schematic diagram illustrating an example of a range in which an abnormality notification in the second example o f the configuration of the communication system according to the present disclosure is transmitted.

FIG. 21 is a flowchart schematically illustrating an operation relating to a packet reception process of a relay apparatus in the second example of the configuration of the communication system according to the present disclosure.

FIG. 22 is a flowchart schematically illustrating an operation relating to a packet transmission process of a relay apparatus in the second example of the configuration of the communication system according to the present disclosure.

FIG. 23 is a block diagram schematically illustrating an example of a configuration of a relay apparatus according to the present disclosure.

FIG. 24 is a block diagram schematically illustrating a configuration of hardware resources.

### DESCRIPTION OF EMBODIMENTS

Hereinafter, modes will be described with reference to drawings. In the present application, various components in the drawings, etc., are denoted by reference characters, to facilitate understanding of the present invention. Thus, the use of these reference characters is not intended to limit the present invention to what is illustrated in the drawings, etc. The following modes are only examples, and the present invention is not limited thereto. An individual connection line between blocks in the drawings, etc., that are referred to in the following description includes both one-way and two-way directions. An arrow schematically illustrates a principal signal (data) flow and does not exclude bidirectionality. In addition, while not explicitly illustrated in the circuit diagrams, the block diagrams, the internal configuration diagrams, the connection diagrams, etc., in the disclosure of the present application, an input port and an output port exist at an input end and an output end of an individual connection line. The same holds true for the input-output interfaces. A program is executed via a computer apparatus, and the computer apparatus includes, for example, a processor, a storage device, an input device, a communication interface, and as needed, a display device. The computer apparatus is configured to communicate with its internal devices or external apparatuses (including computers) via the communication interface in a wired or wireless manner.

### [Mode 1]

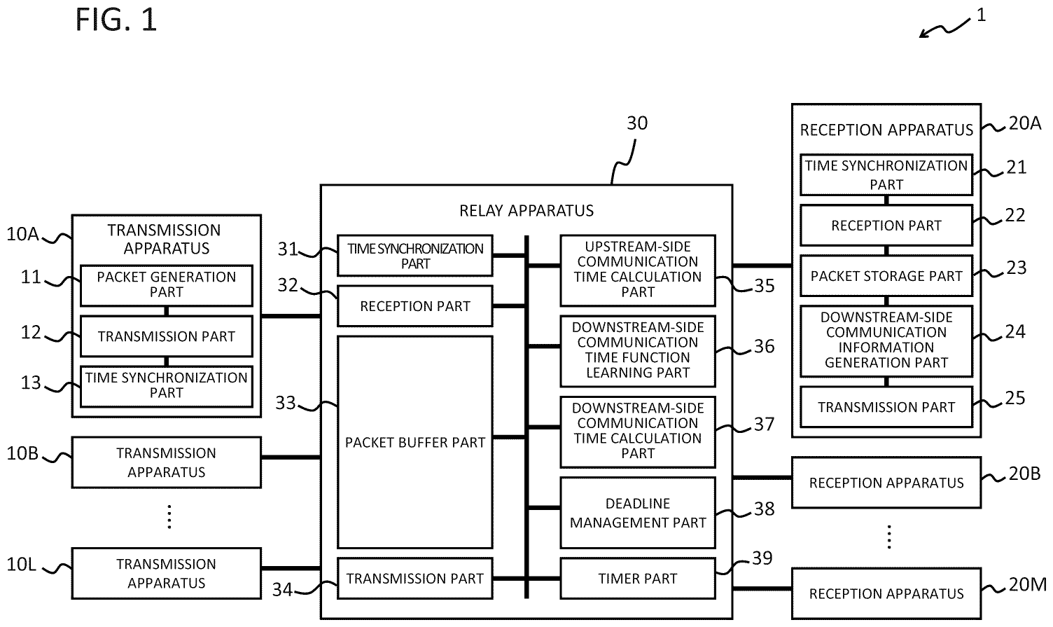

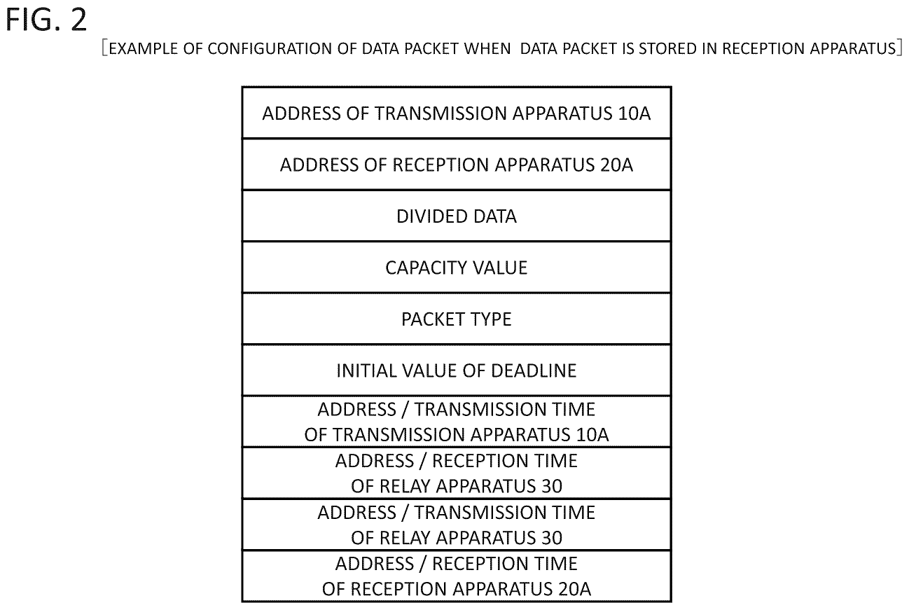

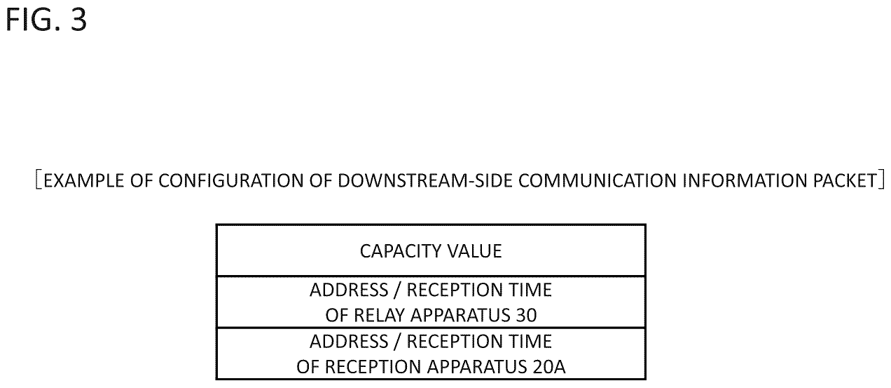

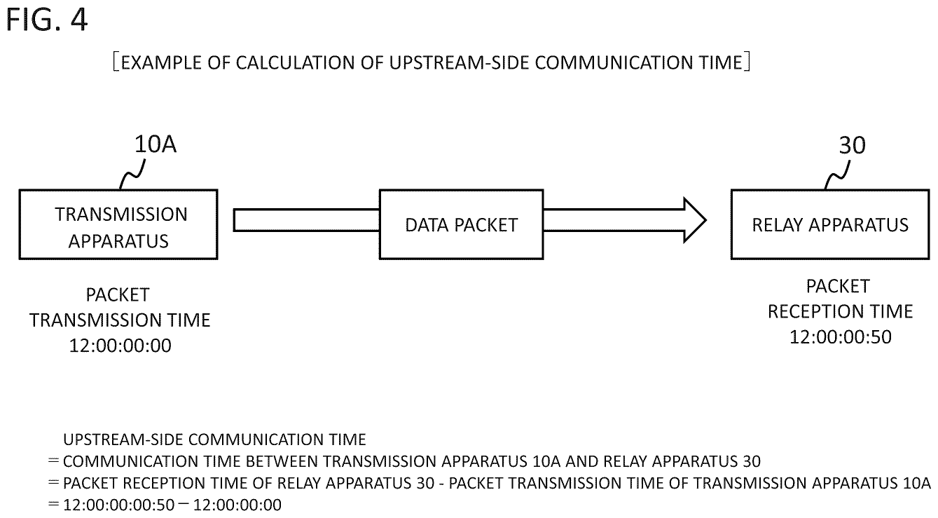

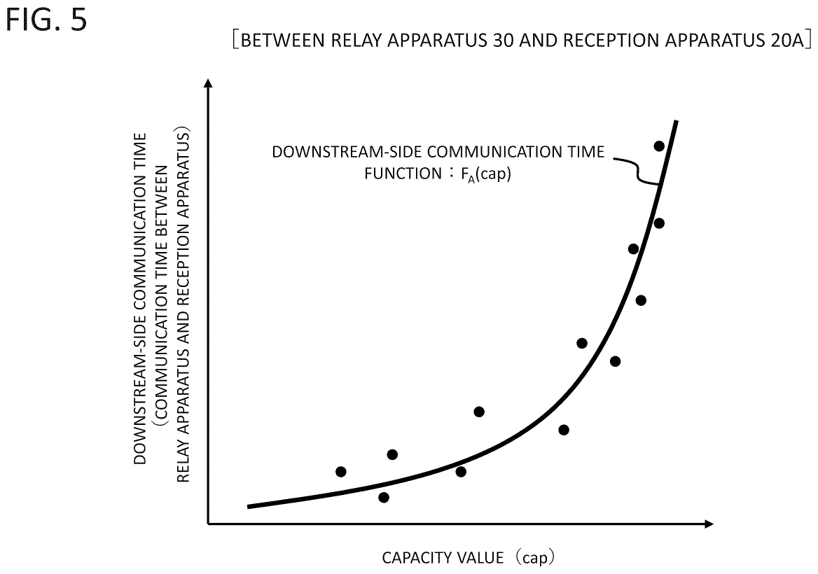

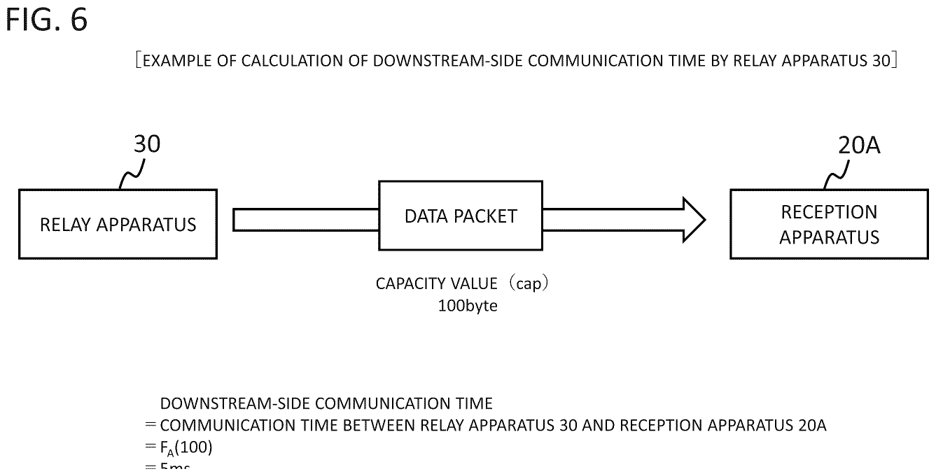

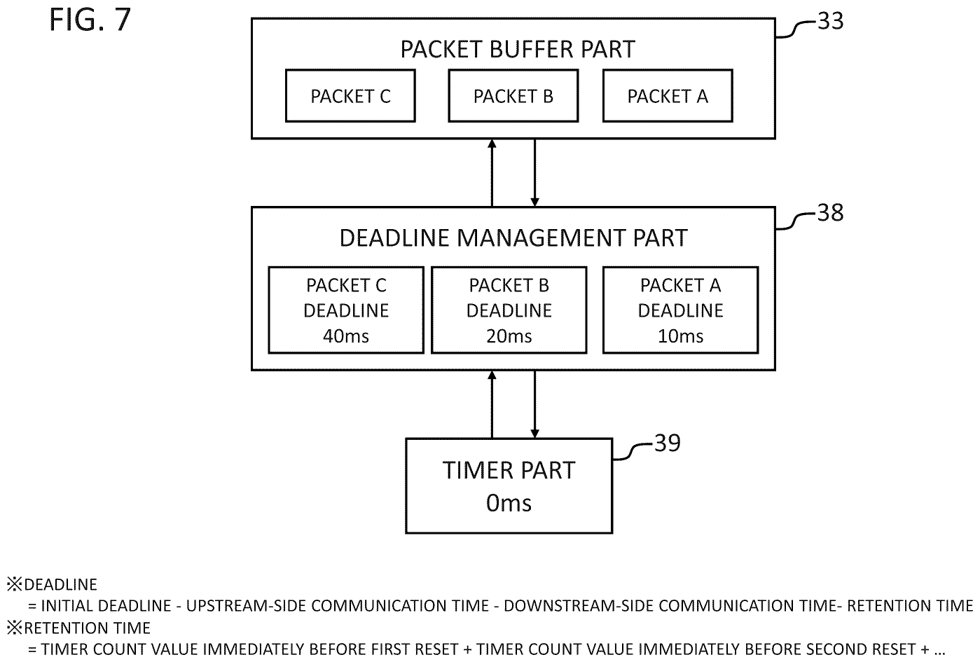

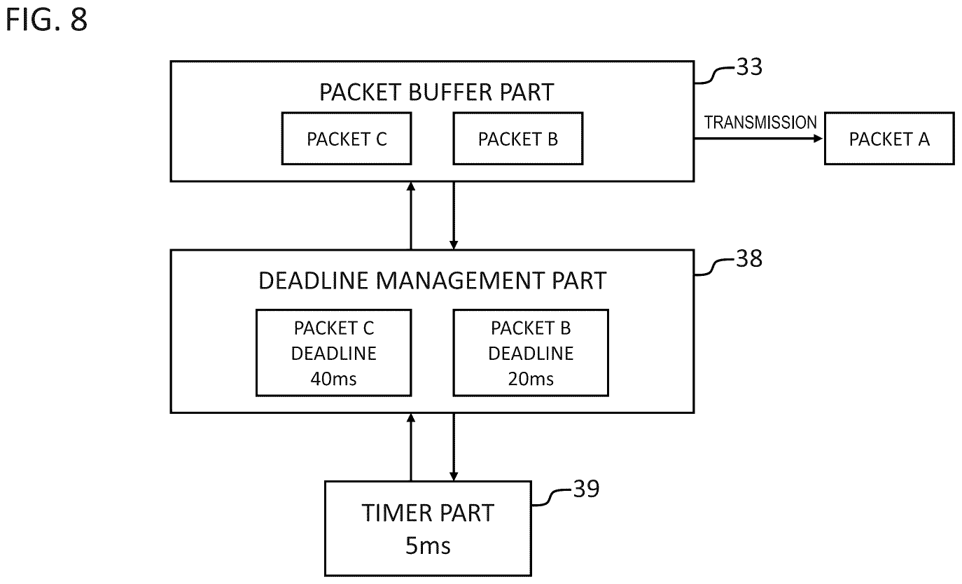

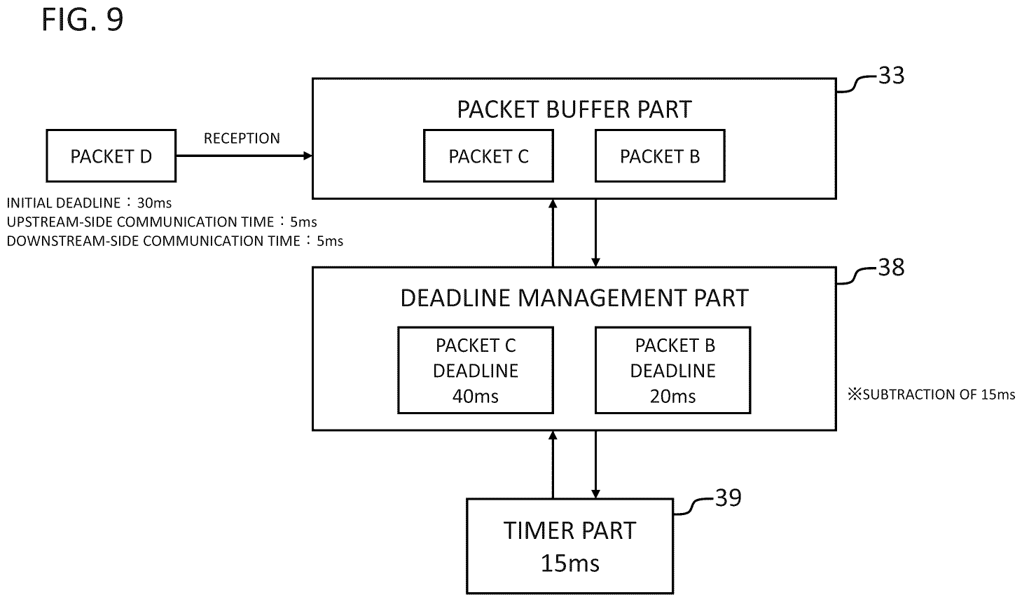

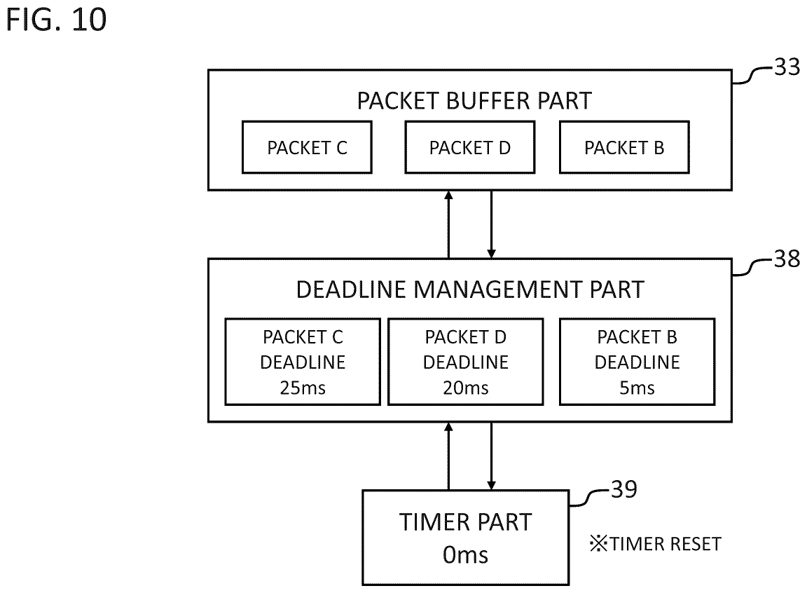

A communication system according to mode 1 will be described with reference to drawings. FIG. 1 is a block diagram schematically illustrating a first example of a configuration of a communication system according to the present disclosure. FIG. 2 is a schematic diagram illustrating an example of a configuration of a data packet when the data packet is stored in a reception apparatus in the first example of the configuration of the communication system according to the present disclosure. FIG. 3 is a schematic diagram illustrating an example of a configuration of a downstream-side communication information packet in the first example of the configuration of the communication system according to the present disclosure. FIG. 4 is a schematic diagram illustrating an example of calculation of an upstream-side communication time by a relay apparatus in the first example of the configuration of the communication system according to the present disclosure. FIG. 5 is a schematic diagram illustrating an example of a downstream-side communication time function used by the relay apparatus in the first example of the configuration of the communication system according to the present disclosure. FIG. 6 is a schematic diagram illustrating an example of calculation of a downstream-side communication time by the relay apparatus in the first example of the configuration of the system according to the present communication disclosure. FIG. 7 is a schematic diagram illustrating an example of the state of a packet buffer part and a deadline management part when a timer part is reset in the relay apparatus in the first example of the configuration of the communication system according to the present disclosure. FIG. 8 is a schematic diagram illustrating an example of the state of the timer part, the packet buffer part, and the deadline management part when the relay apparatus in the first example of the configuration of the communication system according to the present disclosure transmits a packet A after the state in FIG. 7. FIG. 9 is a schematic diagram illustrating an example of the state of the timer part, the packet buffer part, and the deadline management part immediately before the relay apparatus in the first example of the configuration of the communication system according to the present disclosure receives a packet D after the state in FIG. 8. FIG. 10 is a schematic diagram illustrating an example of the state of the packet buffer part and the deadline management part when the relay apparatus in the first example of the configuration of the communication system according to the present disclosure receives the packet D and the timer part is reset after the state in FIG. 9.

Herein, “upstream-side” refers to the direction of transmission apparatuses 10A to 10L on a communication path with respect to a relay apparatus 30, and “downstream-side” refers to the direction of reception apparatuses 20A to 20M on the communication path with respect to the relay apparatus 30.

A communication system 1 is a system in which the transmission apparatuses 10A to 10L and the reception apparatuses 20A to 20M are connected to each other and communicate with each other via the relay apparatus 30 (see FIG. 1). The communication system 1 is configured such that an individual data packet generated and transmitted by any one of the transmission apparatuses 10A to 10L is received by one of the reception apparatuses 20A to 20M, this one reception apparatus being specified by the data packet, via the relay apparatus 30. The communication system 1 is provided with the transmission apparatuses 10A to 10L, the relay apparatus 30, and the reception apparatuses 20A to 20M. The number of transmission apparatuses 10A to 10L May be two or more, but at least one apparatus is sufficient. Similarly, the number of reception apparatuses 20A to 20M may be two or more, but at least one apparatus is sufficient.

Each of the transmission apparatuses 10A to 10L is an apparatus having a function of transmitting packets to the reception apparatuses 20A to 20M (see FIG. 1). The transmission apparatuses 10A to 10L are connected to and communicate with the relay apparatus 30 in a wired or wireless manner. As an individual one of the transmission apparatuses 10A to 10L, for example, hardware resources such as a server, a personal computer, a smartphone, a tablet terminal, a robot, a camera, a microphone, or a telephone having a computer function may be used. Alternatively, a virtual server virtually realized on a cloud may be used. An individual one of the transmission apparatuses 10A to 10L may be configured to virtually is provided with a packet generation part 11, a transmission part 12, and a time synchronization part 13 by executing a stored predetermined program.

The packet generation part 11 is a functional part that divides data, which will be transmitted from itself (transmission apparatus) to a reception apparatus (corresponding reception apparatus among 20A to 20M), into divided data in accordance with a predetermined protocol and generates data packets (see FIG. 1). The packet generation part 11 includes divided data, which has been obtained by dividing the data, in a data packet. A data packet generated by the packet generation part 11 includes, of all configuration data of the data packet in FIG. 2, a transmission apparatus address, a reception apparatus address, divided data, a packet type, a capacity value, and an initial deadline. The packet generation part 11 includes a preset address of itself (transmission apparatus) in the data packet. The packet generation part 11 includes a specified or preset address of one of the reception apparatuses 20A to 20M in the data packet. The packet generation part 11 includes a packet type corresponding to the type of the data (for example, video, audio, chat, text, control, etc.,) in the data packet. The packet generation part 11 measures the capacity value of the divided data included in the data packet and includes the capacity value in the data packet. The packet generation part 11 includes an initial deadline that specifies the initial value of allowable the transmission 10 time of the communication from apparatus specified by the transmission apparatus address to the reception apparatus specified by the reception apparatus address, in the data packet. The initial deadline can be specified, for example, by using a table in which packet types (capacity values or the like) and initial deadline are associated with each other in advance and by acquiring the initial deadline corresponding to the packet type (or the capacity value or the like) included in the data packet. A smaller initial deadline is set for a data packet having a higher transmission priority, and a lager initial deadline is set for a data packet having a lower transmission priority. The packet generation part 11 outputs the generated data packet to the transmission part 12.

The transmission part 12 is a functional part that transmits the data packet from the packet generation part 11 (see FIG. 1). The data packet transmitted from the transmission part 12 includes, of all the configuration data of the data packet in FIG. 2, the transmission apparatus address, the reception apparatus address, the divided data, the packet type, the capacity value, the initial deadline, and a transmission apparatus address/transmission time. When transmitting the data packet, the transmission part 12 records (writes) the transmission apparatus address/transmission time of itself (transmission apparatus) in the data packet. When recording the transmission time, the transmission part 12 acquires the time (current time) from the time synchronization part 13, and records the acquired time as the transmission time of itself (transmission apparatus).

The time synchronization part 13 is a functional part that synchronizes a time of itself (transmission apparatus) with each time of the relay apparatus 30 and the reception apparatuses 20A to 20M (see FIG. 1). The time synchronization part 13 may execute the time synchronization process by, for example, requesting an NTP (Network Time Protocol) server (not illustrated), which executes time synchronization by using a GPS (Global Positioning System) or an atomic clock, for the time via a network (not illustrated) and acquiring the time from the NTP server, which has received the request. The time synchronized by the time synchronization part 13 is used by the transmission part 12.

The relay apparatus 30 is an apparatus having a function of selectively relaying data packets from the transmission apparatuses 10A to 10L to the reception apparatuses 20A to 20M (see FIG. 1). The relay apparatus is connected to and communicates with the transmission apparatuses 10A to 10L and the reception apparatuses 20A to 20M in a wired or wirelessly manner. Examples of the relay apparatus 30 include a switching hub, a router, and a repeater having a computer function and a relay function. The relay apparatus 30 may be configured to be virtually provided with a time synchronization part 31, a reception part 32, a packet buffer part 33, a transmission part 34, an upstream-side communication time calculation part 35, a downstream-side communication time function learning part 36, a downstream-side communication time calculation part 37, a deadline management part 38, and a timer part 39, by executing a stored predetermined program.

The time synchronization part 31 is a functional part that synchronizes a time of itself (relay apparatus 30) with each time of the transmission apparatuses 10A to 10L and the reception apparatuses 20A to 20M (see FIG. 1). The time synchronization part 31 may execute the time synchronization process by, for example, requesting an NTP server (not illustrated) for the time via a network (not illustrated) and acquiring the time from the NTP server, which has received the request. The time synchronized by the time synchronization part 31 is used by the reception part 32 and the transmission part 34.

The reception part 32 is a functional part that receives packets (see FIG. 1). The reception part 32 receives data packets from the transmission apparatuses 10A to 10L. A data packet received by the reception part 32 includes, of all the configuration data of the data packet in FIG. 2, the transmission apparatus address, the reception apparatus address, the divided data, the packet type, the capacity value, the initial deadline, the transmission apparatus address/transmission time, and a relay apparatus address/reception time. When receiving the data packet, the reception part 32 records (writes) the relay apparatus address/reception time of itself (relay apparatus 30) in the data packet. When recording the reception time, the reception part 32 acquires the time (current time) from the time synchronization part 31, and records the acquired time as the reception time of itself (relay apparatus 30). The reception part 32 outputs the received data packet to the packet buffer part 33. The reception part 32 receives downstream-side communication information packets from the reception apparatuses 20A to 20M (see FIG. 3). The reception part 32 outputs the received downstream-side communication information packets to the downstream-side communication time function learning part 36.

The packet buffer part 33 is a functional part that temporarily stores the data packets from the reception part 32 (see FIG. 1). The packet buffer part 33 outputs the stored data packets to the transmission part 34. When a plurality of data packets is stored, the packet buffer part 33 refers to the value of deadline of each data packet updated in the deadline management part 38, and outputs a data packet having the minimum value of deadline to the transmission part 34 with highest priority. When a plurality of updated data packets having the minimum value of deadline are stored in the deadline management part 38, the packet buffer part 33 may output a data packet stored the earliest (or a data packet of which the initial deadline is the smallest) to the transmission part 34 with highest priority. When a data packet is transmitted from the transmission part 34, the packet buffer part 33 deletes the transmitted data packet.

The transmission part 34 is a functional part that transmits the data packets from the packet buffer part 33 (see FIG. 1). The transmission part 34 acquires a data packet corresponding to the minimum value of deadline in the deadline management part 38 from the packet buffer part 33. The transmission part 34 records (writes) a relay apparatus address/transmission time of itself (relay apparatus 30) in the acquired data packet. When recording the transmission time, the transmission part 34 acquires the time (current time) from the time synchronization part 31, and records the acquired time as the transmission time of itself (relay apparatus 30). The transmission part 34 transmits the data packet in which the relay apparatus address/transmission time has been recorded to the reception apparatus (the reception apparatus specified by the reception apparatus address in the data packet). The data packet transmitted from the transmission part 34 includes, of all the configuration data of the data packet in FIG. 2, the transmission apparatus address, the reception apparatus address, the divided data, the packet type, the capacity value, the initial deadline, the transmission apparatus address/transmission time, the relay apparatus address/reception time, and the relay apparatus address/transmission time.

The upstream-side communication time calculation part 35 is a functional part that calculates an upstream-side communication time (see FIG. 1). The upstream-side communication time is communication time from one of the transmission apparatuses 10A to 10L to the relay apparatus 30. The upstream-side communication time is present for each of the transmission apparatuses 10A to 10L. The upstream-side communication time calculation part 35 calculates an upstream-side communication time by referring to the data in a data packet stored in the packet buffer part 33 and calculating the difference between the reception time of the relay apparatus 30 and the transmission time of the transmission apparatus (corresponding transmission apparatus among 10A to 10L) (see FIG. 4). The upstream-side communication time calculated by the upstream-side communication time calculation part 35 is used by the deadline management part 38 to calculate the deadline.

The downstream-side communication time function learning part 36 is a functional part that learns a downstream-side communication time function by using the data in a downstream-side communication information packet (see FIG. 3) (see FIG. 1). The downstream-side communication time function learning part 36 holds the latest and past downstream-side communication information packets from the reception part 32. The downstream-side communication time function learning part 36 calculates, per downstream-side communication information packet, a downstream-side communication time, which is the communication time between the relay apparatus to a reception apparatus, by calculating the difference between the reception time of the relay apparatus 30 and the reception time of the reception apparatus (corresponding reception apparatus among 20A to 20M) by using the data in a stored downstream-side communication information packet. Based on a calculated downstream-side communication time and a capacity value in the corresponding downstream-side communication information packet, the downstream-side communication time function learning part 36 learns a downstream-side communication time function for calculating a downstream-side communication time according to the capacity value. A downstream-side communication time function is present for each of the reception apparatuses 20A to 20M. For example, the downstream-side communication time function between the relay apparatus 30 and the reception apparatus 20A is expressed by FA (cap) in FIG. 5. A downstream-side communication time function may be learned by, for example, creating a scatter diagram in which points, which indicate the downstream-side communication time and the capacity value of the individual downstream-side communication information packet, are plotted in a graph in which the X axis represents the capacity value and the Y axis represents the downstream-side communication time, creating a regression line based on the created scatter diagram, and calculating a function, which uses the capacity value of the created regression line as a variable (see FIG. 5). The downstream-side communication time function learning part 36 may learn a downstream-side communication time function at an arbitrary or predetermined timing. The downstream-side communication time function learning part 36 holds the latest learned downstream-side communication time function(s). The downstream-side communication time function(s) held by the downstream-side communication time function learning part 36 is used by the downstream-side communication time calculation part 37 to calculate a downstream-side communication time.

The downstream-side communication time calculation part 37 is a functional part that calculates a downstream-side communication time (see FIG. 1). The downstream-side communication time calculation part 37 assigns the capacity value in a data packet stored in the packet buffer part 33 to a corresponding downstream-side communication time function stored in the downstream-side communication time function learning part 36, so as to calculate the downstream-side communication time of the data packet (see FIG. 6). A downstream-side communication time calculated by the downstream-side communication time calculation part 37 is used by the deadline management part 38 to calculate the deadline.

The deadline management part 38 is a functional part that manages a deadline according to each data packet stored in the packet buffer part 33 (see FIG. 1). The deadline can be calculated by subtracting the corresponding upstream-side communication time calculated by the upstream-side communication time calculation part 35, the corresponding downstream-side communication time calculated by the downstream-side communication time calculation part 37, and the corresponding retention time from the initial deadline included in the data packet (see FIG. 7). The retention time is time for which the corresponding data packet has remained in the packet buffer part 33, and is a value obtained by adding a timer count value immediately before the reset each time the timer part 39 is reset. When the deadline of a new data packet (in FIG. 7, the deadline of a packet C; the retention time is 0) is stored, when the deadlines of the existing data packets stored in the packet buffer part 33 (in FIG. 7, each of the deadlines of packets A and B) are updated, and when a data packet having the minimum value of deadline (in FIG. 7, the packet A) is transmitted from the packet buffer part 33 after the timer part 39 is reset to 0, the deadline management part 38 deletes the deadline of the transmitted data packet (in FIG. 8, the deadline of the packet A). When a new data packet (for example, a packet D in FIGS. 9 and 10) is inputted to and stored in the packet buffer part 33, the deadline management part 38 calculates and stores the deadline of the new data packet (in FIG. 9, the deadline of the packet D), updates the deadline of each existing data packet stored in the packet buffer part 33 (in FIG. 9, the packets B and C) (recalculation; subtracts the timer count value of the timer part 39 (in FIG. 9, 15 ms) from each of the previously updated deadlines (in FIG. 9, 20 ms and 40 ms)), and resets the timer part 39 to 0 (see FIG. 10). The deadlines of the data packets managed by the deadline management part 38 are used by the packet buffer part 33.

The timer part 39 is a functional part that counts the retention time of the individual data packet stored in the packet buffer part 33 by delimiting thereof (see FIG. 1). When the deadline of a new data packet is inputted to the deadline management part 38, the timer part 39 resets its timer count value to 0 and continues its counting. The timer count value counted by the timer part 39 is used for updating (calculating) the deadline of the existing data packet stored in the packet buffer part 33 when the deadline of a new data packet is inputted to the deadline management part 38.

The reception apparatuses 20A to 20M are each an apparatus that has a function of receiving data from the transmission apparatuses 10A to 10L (see FIG. 1). The reception apparatuses 20A to 20M are connected to and communicate with the relay apparatus 30 in a wired or wireless manner. As an individual one of the reception apparatuses 20A to 20M, for example, hardware resources such as a server, a personal computer, a smartphone, a tablet terminal, a robot, a camera, a microphone, or a telephone having a computer function may be used.

Alternatively, a virtual server virtually realized on a cloud may be used. The reception apparatuses 20A to 20M may be configured to be virtually provided with a time synchronization part 21, a reception part 22, a packet storage part 23, a downstream-side communication information generation part 24, and a transmission part by executing a stored predetermined program. Although the reception apparatuses 20A to 20M and the transmission apparatuses 10A to 10L are illustrated as different kinds of apparatuses for convenience of description in FIG. 1, each of the reception apparatuses 20A to 20M may also serve as a transmission apparatus, and each of the transmission apparatuses 10A to 10L may also serve as a reception apparatus.

The time synchronization part 21 is a functional part that synchronizes the time of itself (reception apparatus) with each time of the transmission apparatuses 10A to 10L and the relay apparatus 30 (see FIG. 1). The time synchronization part 21 may execute the time synchronization process by, for example, requesting an NTP server (not illustrated) for the time via a network (not illustrated) and acquiring the time from the NTP server, which has received the request. The time synchronized by the time synchronization part 21 is used by the reception part 22.

The reception part 22 is a functional part that receives data packets from the relay apparatus 30 (see FIG. 1). As illustrated in FIG. 2, a data packet received by reception part 22 includes the transmission apparatus address, the reception apparatus address, the divided data, the packet type, the capacity value, the initial deadline, the transmission apparatus address/transmission time, the relay apparatus address/reception time, the relay apparatus address/transmission time, and a reception apparatus address/reception time. When receiving a data packet, the reception part 22 records (writes) the reception apparatus address/reception time of itself (reception apparatus) in the data packet. When recording the reception time, the reception part 22 acquires the time from the time synchronization part 21, and records the acquired time as the reception time of itself (reception apparatus). The reception part 22 outputs the received data packet to the packet storage part 23.

The packet storage part 23 is a functional part that stores the data packets received by the reception part 22 (see FIG. 1). The data packets received by the packet storage part 23 are reconstructed and output based on their respective packet types (video output, audio output, display, control, etc.).

The downstream-side communication information generation part 24 is a functional part that generates a downstream-side communication information packet relating to the communication of downstream-side (reception apparatus side) of the relay apparatus 30 based on a data packet stored in the packet storage part 23 (see FIG. 1). The downstream-side communication information generation part May 24 generate a downstream-side communication information packet for each of the data packets stored in the packet storage part 23. Alternatively, the downstream-side communication information generation part ma y 24 generate a downstream-side communication information for only a data packet stored at an arbitrary or predetermined timing. For example, as illustrated in FIG. 3, a downstream-side communication information packet may be configured to include the capacity value, the relay apparatus address/reception time, and the reception apparatus address/reception time. The capacity value included in the downstream-side communication information packet is not the capacity value of the downstream-side communication information packet itself, but the capacity value of the data packet that is used as a basis of the generation of this downstream-side communication information packet. The relay apparatus address/reception apparatus address/downstream-side communication time may be used in place of the relay apparatus address/reception time and the reception apparatus address/reception time. The downstream-side communication time is the difference between the reception time of the reception apparatus address and the reception time of the relay apparatus address. The downstream-side communication information generation 24 outputs the generated downstream-side 20 part communication information packet to the transmission part 25.

The transmission part 25 is a functional part that transmits the downstream-side communication information packet generated by the downstream-side communication information generation part 24 to the relay apparatus 30 (see FIG. 1).

An operation of the relay apparatus in the communication system according to mode 1 will be described.

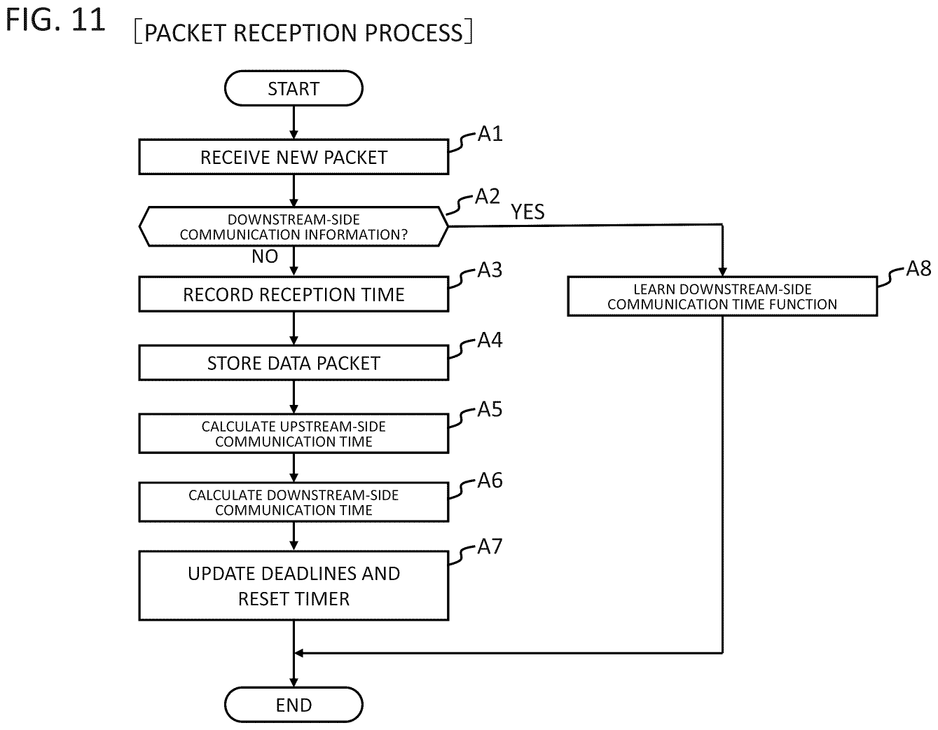

First, an operation relating to a packet reception process of the relay apparatus in the communication system according to mode 1 will be described with reference to drawings. FIG. 11 is a flowchart schematically illustrating an operation relating to a packet reception process of the relay apparatus in the first example of the configuration of the communication system according to the present disclosure. The communication system has the configuration illustrated in FIG. 1.

First, the reception part 32 in the relay apparatus receives a new data packet from a transmission apparatus (for example, the transmission apparatus 10A) or a new downstream-side communication information packet (see FIG. 3) from a reception apparatus (for example, the reception apparatus 20A) (step A1).

Next, the reception part 32 determines whether or not the received packet is a downstream-side communication information packet (step A2). If the received packet is a downstream-side communication information packet (YES in step A2), the process proceeds to step A8.

If the received packet is not a downstream-side communication information packet (NO in step A2; if the received packet is a data packet), the reception part 32 records (writes) the relay apparatus address/reception time of itself (relay apparatus 30) in the data packet (step A3).

Next, the packet buffer part 33 in the relay apparatus 30 acquires the data packet in which the relay apparatus address/reception time has been recorded from the reception part 32 and stores the data packet (step A4).

Next, the upstream-side communication time calculation part 35 in the relay apparatus 30 refers to the data in the latest data packet stored in the packet buffer part 33, and calculates the upstream-side communication time by calculating the difference between the reception time of the relay apparatus 30 and the transmission time of the reception apparatus (for example, the transmission apparatus 10A) (step A5).

Next, the downstream-side communication time calculation part 37 in the relay apparatus 30 assigns the capacity value in the latest data packet stored in the packet buffer part 33 to the downstream-side communication time function held by the downstream-side communication time function learning part 36, to calculate the downstream-side communication time of the data packet (step A6). Step A6 may be executed before step A5 or simultaneously with step A5.

Next, the deadline management part 38 in the relay apparatus 30 updates (calculates) the deadlines of the individual data packets stored in the packet buffer part 33, and resets the timer part 39 to 0 (step A7). Next, the process proceeds to END and returns to START. Regarding the updating of the deadlines, the deadline of the latest data packet stored in the packet buffer part 33 is calculated and stored, and the deadlines of the individual existing data packets stored in the packet buffer part 33 are updated (the timer count value of the timer part 39 is subtracted from the individual deadline previously updated). After resetting the timer count value, the timer part 39 continues its counting.

If the received packet is a downstream-side communication information packet (YES in step A2), the downstream-side communication time function learning part 36 in the relay apparatus 30 acquires the downstream-side communication information packet from the reception part 32, and learns a downstream-side communication time function by using the data in the acquired downstream-side communication information packet (including the latest and/or an existing downstream-side communication information packet) (step A8). Next, the process proceeds to End.

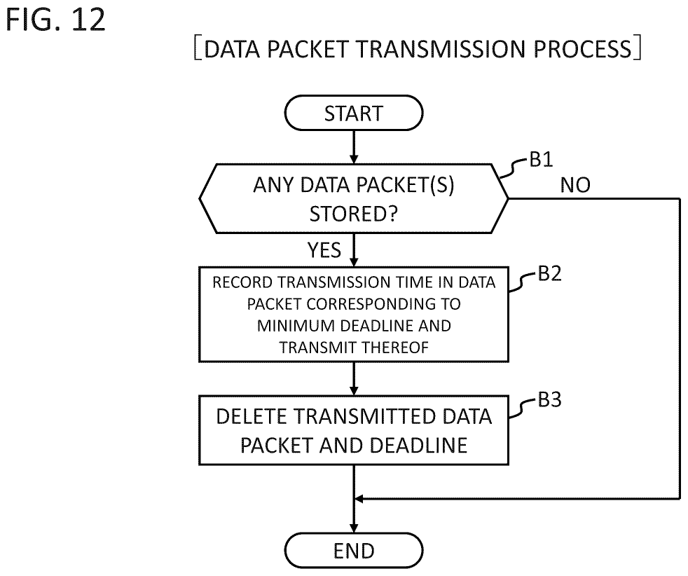

Next, an operation relating to a packet transmission process of the relay apparatus in the communication system according to mode 1 will be described with reference to drawings. FIG. 12 is a flowchart schematically illustrating an operation relating to a packet transmission process of the relay apparatus in the first example of the configuration of the communication system according to the present disclosure. The communication system has the configuration illustrated in FIG. 1.

First, the packet buffer part 33 in the relay apparatus 30 determines whether or not a data packet(s) is stored in itself (relay apparatus 30) (step B1). If no data packet is stored (NO in step B1), the process proceeds to END and returns to START. 30

If a data packet(s) is stored (YES in step B1), the transmission part 34 in the relay apparatus 30 acquires a data packet corresponding to the minimum value of the deadline in the deadline management part 38 from the packet buffer part 33, records (writes) the relay apparatus address/transmission time of itself (relay apparatus 30) in the acquired data packet, and transmits the data packet in which the relay apparatus address/transmission time has been recorded to the reception apparatus (the reception apparatus according to the reception apparatus address in the data packet) (step B2).

Next, the packet buffer part 33 deletes the transmitted data packet, and the deadline management part 38 deletes the deadline of the transmitted data packet (step B3). Next, the process proceeds to END and returns to START.

According to mode 1, the relay apparatus 30 transmits (outputs), with highest priority, a data packet having the minimum value of deadline of all the deadlines, each of which has been calculated by using an upstream-side communication time, a downstream-side communication time, and a data packet retention time in the relay apparatus 30. The upstream-side communication time is a data packet communication time from a transmission apparatus (corresponding transmission apparatus among 10A to 10L) to the relay apparatus 30. The downstream-side communication time is a data packet communication time from the relay apparatus 30 to a reception apparatus (corresponding to the reception apparatus among 20A to 20M). Therefore, by taking into account the retention time and the communication time of the packet inside and outside the relay apparatus 30, the packet relay processing can be accurately controlled to communicate each packet within an appropriate time (deadline).

### [Mode 2]

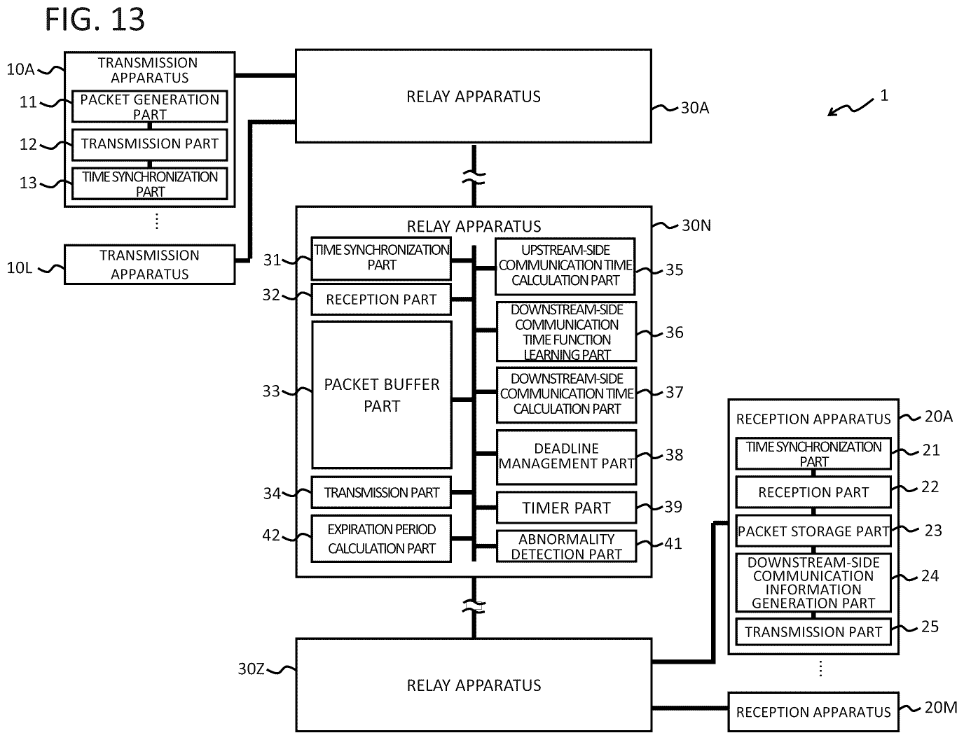

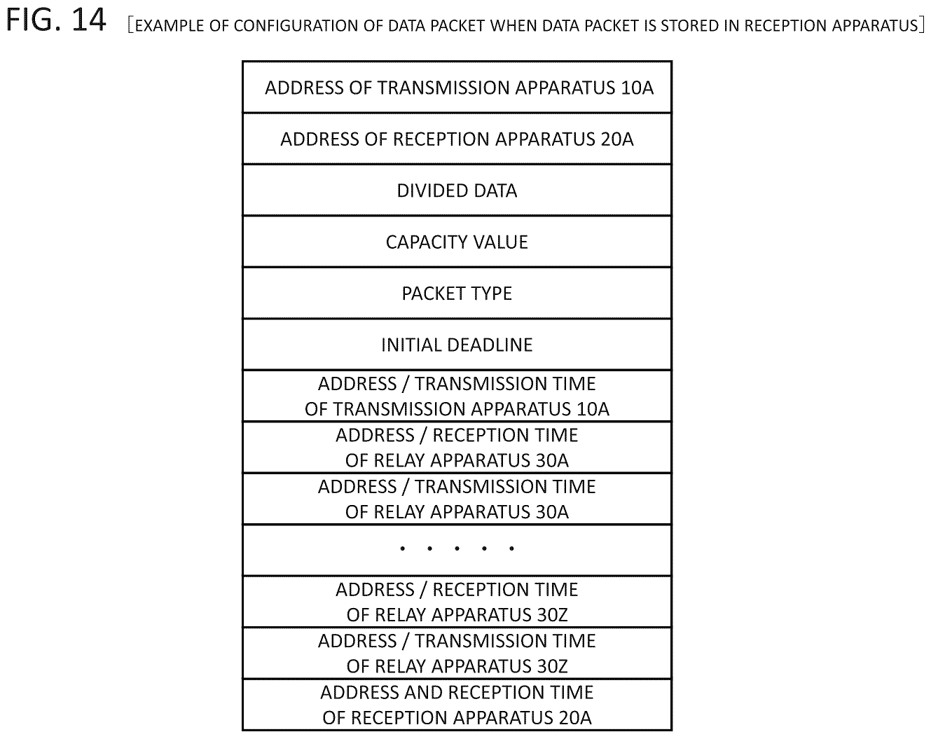

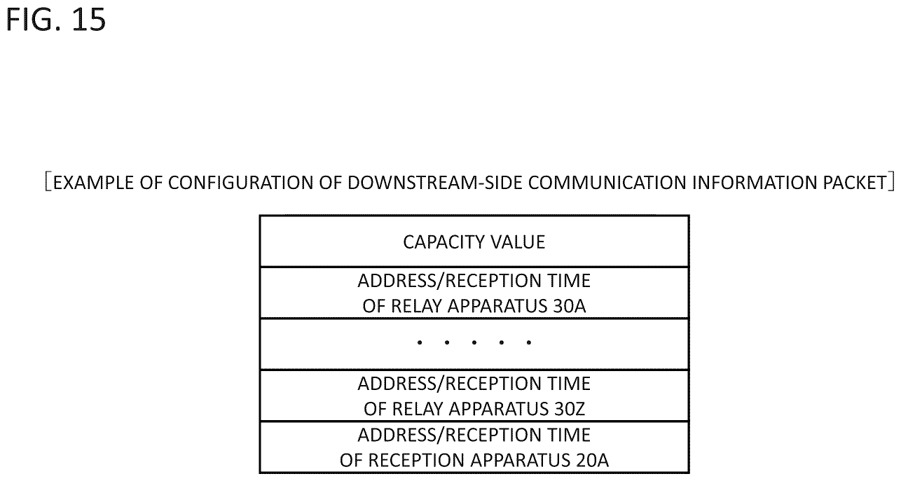

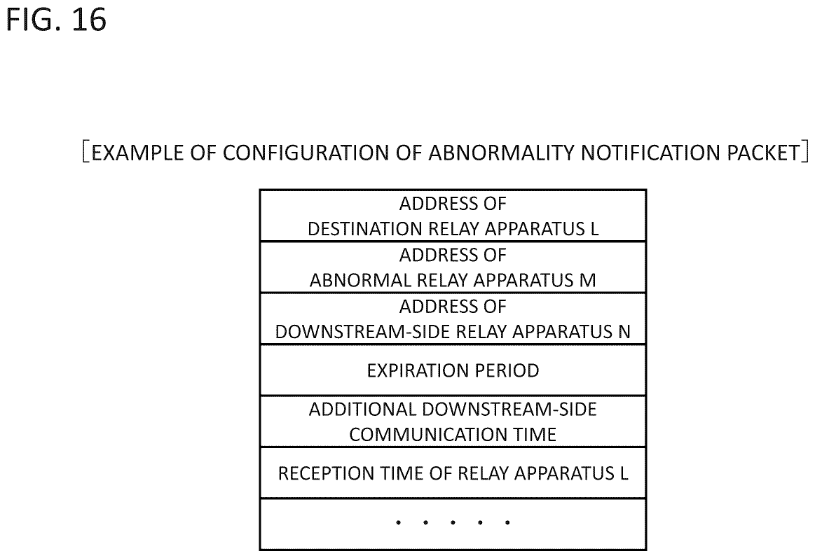

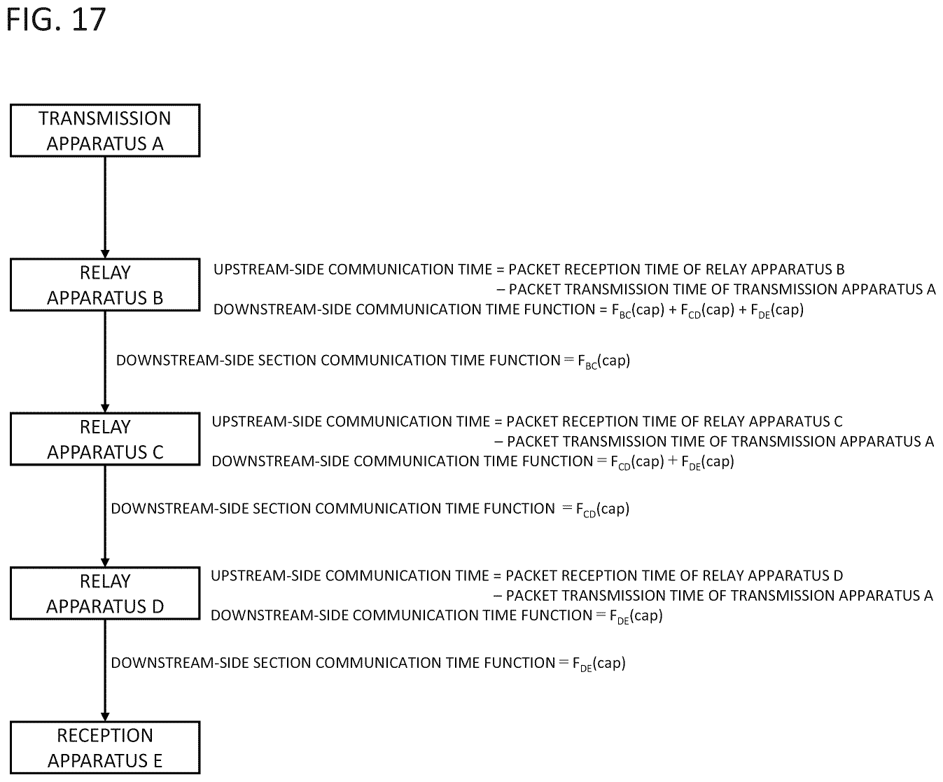

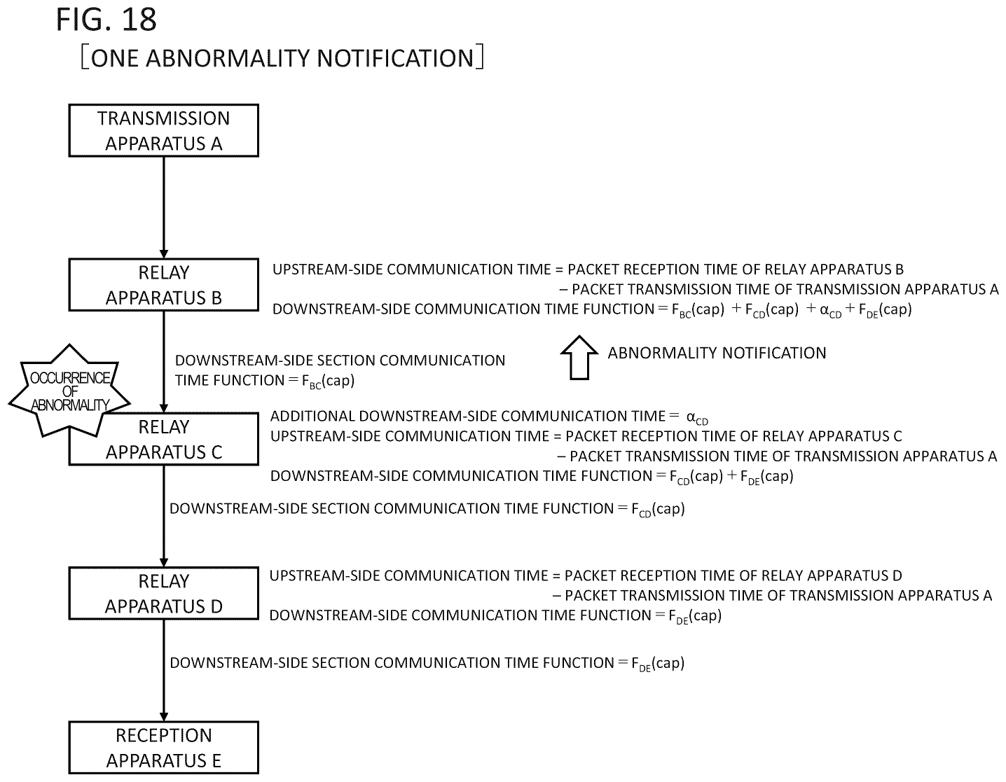

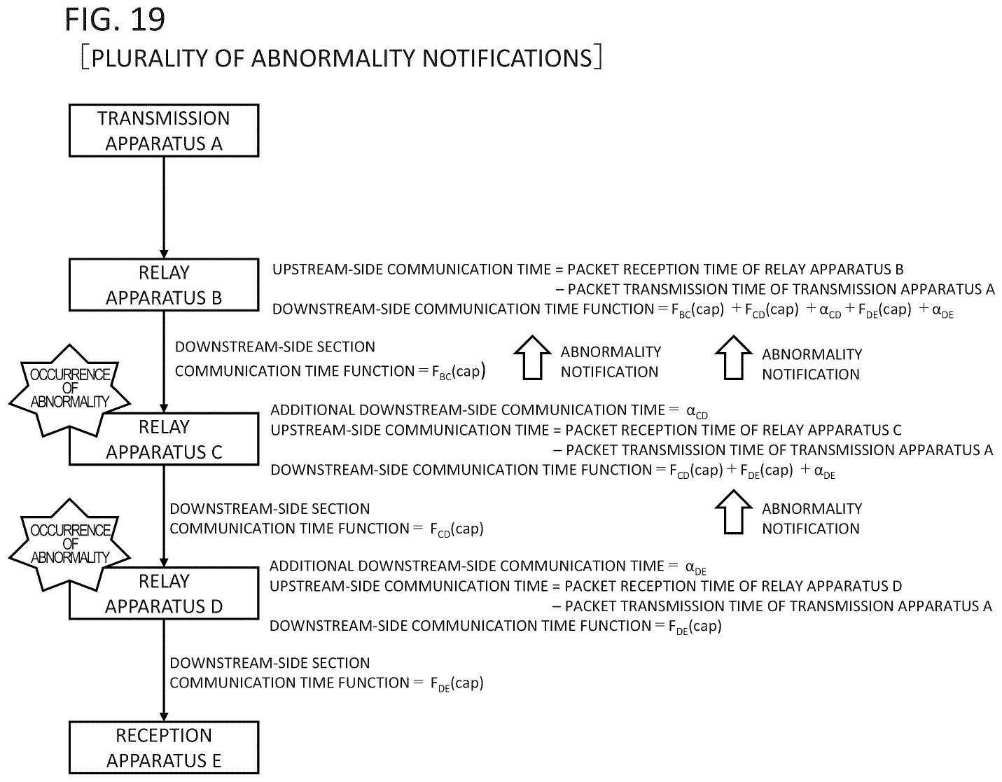

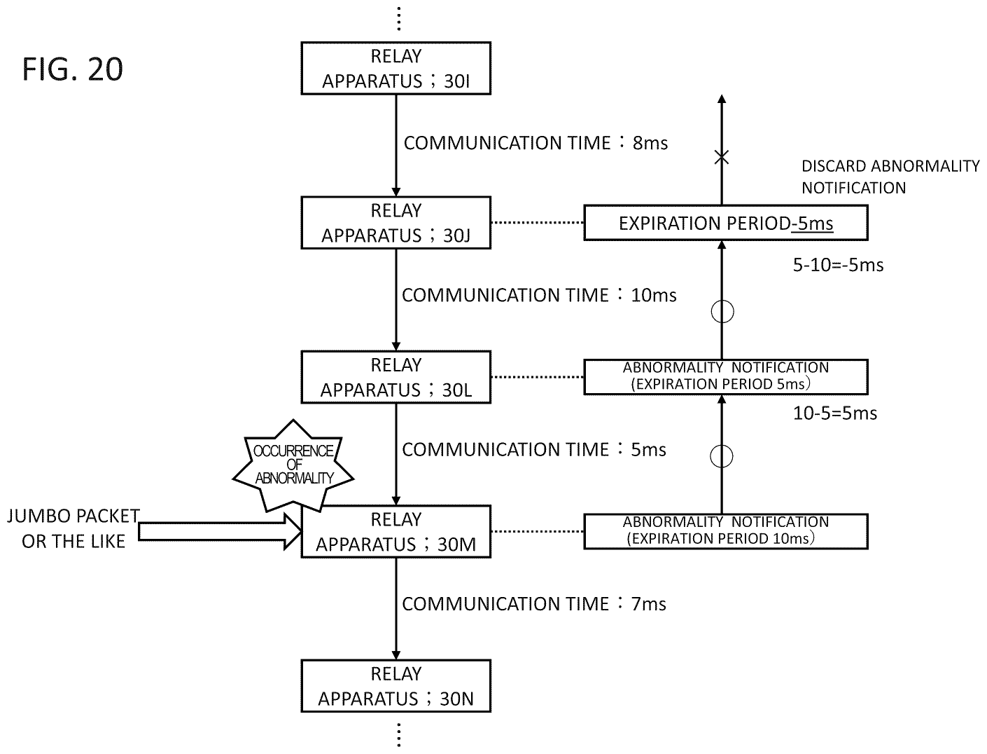

A communication system according to mode 2 will be described with reference to drawings. FIG. 13 is a block diagram schematically illustrating a second example of the configuration of the communication system according to the present disclosure. FIG. 14 is a schematic diagram illustrating an example of a configuration of a data packet when the data packet is stored in a reception apparatus in the second example of the configuration of the communication system according to the present disclosure. FIG. 15 is a schematic diagram illustrating an example of a configuration of a downstream-side communication information packet in the second example of the configuration of the communication system according to the present disclosure. FIG. 16 is a schematic diagram illustrating an example of a configuration of an abnormality notification packet in the second example of the configuration of the communication system according to the present disclosure. FIG. 17 is a schematic diagram illustrating an example of calculation o f an upstream-side communication time an d a downstream-side communication time when there is no abnormality notification of each relay apparatus in a modification example of the second example of the configuration of the communication system according to the present disclosure. FIG. 18 is a schematic diagram illustrating an example of calculation of an upstream-side communication time and a downstream-side communication time when there is one abnormality notification of each relay apparatus according to a modification example of the second example of the configuration of the communication system according to the present disclosure. FIG. 19 is a schematic diagram illustrating an example of calculation of an upstream-side communication time and a downstream-side communication time when there are two abnormality notifications of each relay apparatus according to a modification example of the second example of the configuration of the communication system according to the present disclosure. FIG. 20 is a schematic diagram illustrating an example of a range in which a n abnormality notification in the second example of the configuration of the communication system according to the present disclosure is transmitted.

Mode 2 is a modification of mode 1, and is directed to a communication system 1 having a path of which a plurality (two or more) of relay apparatuses 30A to 30Z are connected in series on a communication path between transmission apparatuses 10A to 10L and reception apparatuses 20A to 20M (see FIG. 13). Although the transmission apparatuses 10A to 10L of mode 2 are the same as those of mode 1 (see FIG. 1), the configuration of the relay apparatuses 30A to 30Z has been modified from that of the relay apparatus 30 of mode 1 (see FIG. 1). The operation of the reception apparatuses 20A to 20M of mode 2 has been partly modified from that of the reception apparatuses 20A to 20M of mode 1 (see FIG. 1).

In mode 2, contents of an abnormality (an expiration period and an additional downstream-side communication time in FIG. 16) that occurs in relay apparatus 30M are notified to its upstream-side relay apparatuses 30A to 30L. The is because if an abnormality (delay, congestion or the like) occurs in any of the relay apparatus 30A to 30Z (for example, the relay apparatus 30M in FIG. 20) due to an input of a jumbo packet (a packet with a large capacity value) or an intensive input of a large number of packets thereto from a communication path not shown in the figure, an expected additional retention time of data packets at the relay apparatus 30M, in which the abnormality occurred, is to be reflected on a downstream-side communication time (communication time between relay apparatus and reception apparatus) of data packets calculated at relay apparatuses 30A to 30L in a communication path upstream-side (transmission apparatuses 10A to 10L side) of the relay apparatus 30M. Because the expected additional retention time of the individual data packet in the relay apparatus 30M in which the abnormality has occurred is reflected on the upstream-side communication time (communication time between transmission apparatus and relay apparatus) of the individual data packet calculated by the relay apparatuses 30N to 30Z on the communication path of downstream-side of the relay apparatus 30M (in the direction of the reception apparatuses 20A to 20M), in mode 2, the relay apparatus 30M may be configured not to notify the relay apparatuses 30N to 30Z of the downstream-side of the content of the abnormality.

In addition, when the relay apparatus 30M notifies all the relay apparatuses 30A to 30L, which are located on the communication path of upstream-side of the relay apparatus 30M, of the content of its abnormality, if the number of relay apparatuses 30A to 30L to be notified is large, the number of notifications may become large and communication may become tightened. Therefore, in mode 2, the range of the notification of the content of the abnormality that has occurred in the relay apparatus 30M is limited to a certain range.

To realize the above-described operation, each of the relay apparatuses 30A to 30Z is provided with an abnormality detection part 41 and an expiration period calculation part 42, in addition to the components of the relay apparatus 30 according to mode 1 (see FIG. 1).

The relay apparatuses 30A to 30Z are connected in series o n the communication path between the transmission apparatuses 10A to 10L and the reception apparatuses 20A to 20M (see FIG. 13). The relay apparatuses 30A to 30Z are connected to and communicate with the transmission apparatuses 10A to 10L and the reception apparatuses 20A to 20M in a wired or wireless manner. Each of the relay apparatuses 30A to 30Z may be configured to be virtually provided with a time synchronization part 31, a reception part 32, a packet buffer part 33, a transmission part 34, an upstream-side communication time calculation part 35, a downstream-side communication time function learning part 36, a downstream-side communication time calculation part 37, a deadline management part 38, a timer part 39, an abnormality detection part 41, and an expiration period calculation part 42, by executing a stored predetermined program.

The time synchronization part 31 synchronizes its (for example, the relay apparatus 30M) own time with each time of other relay apparatuses (for example, the relay apparatuses 30A to 30L and 30N to 30Z), the transmission apparatuses 10A to 10L, and the reception apparatuses 20A to 20M.

The reception part 32 receives a data packet from one of the transmission apparatuses 10A to 10L or from a relay apparatus (corresponding relay apparatus among 30A to 30Y), which is connected upstream-side of and adjacent to itself (relay apparatus). The reception part 32 records (writes) the relay apparatus address/reception time of itself (relay apparatus) in the received data packet, and outputs the data packet to the packet buffer part 33. The data packet received by the reception part 32 includes, of all the configuration data of the data packet in FIG. 14, a transmission apparatus address, a reception apparatus address, divided data, a packet type, a capacity value, an initial deadline, a transmission apparatus address/transmission time, and a relay apparatus address/reception time. If there is another relay apparatus disposed on the communication path between the transmission apparatuses 10A to 10L and itself (relay apparatus), the data packet further includes a relay apparatus address/transmission time. Regarding the relay apparatus address/reception time and the relay apparatus address/transmission time, if there are a plurality of other relay apparatuses o n the communication path between the transmission apparatuses 10A to 10L and itself (relay apparatus), the data packet includes the relay apparatus address/reception time and the relay apparatus address/transmission time for each of the other relay apparatuses.

The reception part 32 receives a downstream-side communication information packet (see FIG. 15) from a relay apparatus (corresponding relay apparatus among 30B to 30Z) or from one of the reception apparatuses 20A to 20M, which is connected downstream-side of and adjacent to itself (relay apparatus), and outputs the received downstream-side communication information packet to the downstream-side communication time function learning part 36.

The reception part 32 receives an abnormality notification packet from a relay apparatus (corresponding relay apparatus among 30B to 30Z), which is connected downstream-side of and adjacent to itself (relay apparatus), records (writes) the relay apparatus address/reception time of itself (relay apparatus 30) in the received abnormality notification packet, and outputs the abnormality notification packet to the abnormality detection part 41.

The transmission part 34 acquires a data packet corresponding to the minimum value of deadline in the deadline management part 38 from the packet buffer part (writes) relay apparatus 33, records the address/transmission time of itself (relay apparatus 30) in the acquired data packet, and transmits the data packet in which the relay apparatus address/transmission time has been recorded to a relay apparatus (corresponding relay apparatus among 30B to 30Z) or a reception apparatus (the reception apparatus according to the reception apparatus address in the data packet).

The upstream-side communication time calculation part 35 refers to the data in a data packet stored in the packet buffer part 33, and calculates the upstream-side communication time by calculating the difference between the reception time of itself (relay apparatus) and the transmission time of the reception apparatus (corresponding reception apparatus among 10A to 10L). The upstream-side communication time calculated by the upstream-side communication time calculation part 35 is used by the deadline management part 38 to calculate the deadline.

The downstream-side communication time function learning part 36 stores the latest and past downstream-side communication information packets according to the relay apparatus, which is connected downstream-side of itself (relay apparatus) (corresponding relay apparatus among 30B to 30Z) or the reception apparatus (corresponding reception apparatus among 20A to 20N) from the reception part 32, and learns a downstream-side communication time function based on the stored downstream-side communication information packets. When storing the latest downstream-side communication information packet, the downstream-side communication time function learning part 36 determines whether or not there is a relay apparatus connected upstream-side of itself (relay apparatus). If there is a relay apparatus connected upstream-side thereof, the downstream-side communication time function learning part 36 transmits the latest downstream-side communication information packet to the relay apparatus connected upstream-side of and adjacent to itself (relay apparatus) (corresponding relay apparatus among 30A to 30Y) via the transmission part 34.

When learning a downstream-side communication time function, for each of the stored downstream-side communication information packets, the downstream-side communication time function learning part 36 calculates the downstream-side section communication time for each section between adjacent apparatuses, using the reception time of itself (relay apparatus) in the downstream-side communication information packet, and each reception time of each relay apparatus at downstream-side of itself (relay apparatus) and the reception apparatuses 20A to 20M at downstream-side of itself (relay apparatus). The downstream-side communication time function learning part 36 learns the downstream-side section communication time function for calculating a downstream-side section communication time according to a capacity value, based on the calculated downstream-side section communication time and the capacity value in the corresponding downstream-side communication information packet. Regarding the downstream-side section communication time function, in the example in FIG. 17, if it is a relay apparatus B, the downstream-side communication time function learning part 36 learns F_{BC} (cap), F_{CD} (cap), and F_{DE} (cap) as the downstream-side section communication time functions. If it is a relay apparatus C, the downstream-side communication time function learning part 36 learns F_{CD} (cap) and F_{DE} (cap) as the downstream-side section communication time functions. If it is a relay apparatus D, the downstream-side communication time function learning part 36 learns F_{DE} (cap) as the downstream-side section communication time functions. The downstream-side communication time function learning part 36 learns a downstream-side communication time function by adding up the learned downstream-side section communication time functions. In the example in FIG. 17, if it is the relay apparatus B, the downstream-side communication time function learning part 36 learns F_{BC} (cap)+F_{CD} (cap)+F_{DE} (cap) as the downstream-side communication time function. If it is the relay apparatus C, the downstream-side communication time function learning part 36 learns F_{CD} (cap)+F_{DE} (cap) as the downstream-side communication time function. If it is the relay apparatus D, the downstream-side communication time function learning part 36 learns F_{DE} (cap) as the downstream-side communication time function. The downstream-side communication time function learning part 36 stores the latest learned downstream-side communication time function. The downstream-side communication time function stored by the downstream-side communication time function learning part 36 is used by the downstream-side communication time calculation part 37 to calculate a downstream-side communication time.

When an additional downstream-side communication time from the abnormality detection part 41 is registered, the downstream-side communication time function learning part 36 learns a downstream-side communication time function that takes into account the registered additional downstream-side communication time. For example, as illustrated in FIG. 18, when an abnormality has occurred in the relay apparatus C and the relay apparatus B has been notified of the abnormality, the relay apparatus B learns F_{BC} (cap)+F_{CD} (cap)+α_{CD}+as the downstream-side communication time F_{DE} (cap) function that takes into account the additional downstream-side communication time α_{CD} in the abnormality notification. This α_{CD} may be a constant or a function using the capacity value of the packet as a variable. The additional downstream-side communication time α_{CD} in the relay apparatus C in FIG. 18 corresponds to the difference between an abnormal retention time and a normal retention time. Because the retention time has been reflected by the timer count in the relay apparatus C, the additional downstream-side communication time α_{CD} is not taken into account in the downstream-side communication time function in the relay apparatus C. In addition, as illustrated in FIG. 19, if an abnormality occurs in the relay apparatus C and the relay apparatus D, the relay apparatus B has been notified of each abnormality in the relay apparatus C and the relay apparatus D, and the relay apparatus C has been notified of the abnormality in the relay apparatus D, the relay apparatus B learns F_{BC} (cap)+F_{CD} (cap)+α_{CD}+F_{DE} (cap)+α_{DE} as the downstream-side communication time function that takes into account the additional downstream-side communication times α_{CD} and α_{DE} in the notifications of each abnormality in the relay apparatus C and the relay apparatus D, and the relay apparatus C learns F_{CD} (cap)+F_{DE} (cap)+α_{DE} as the downstream-side communication time function that takes into account the additional downstream-side communication time α_{DE} in the notification of the abnormality in the relay apparatus D. This α_{DE} may be a constant or a function using the capacity value of the packet as a variable. When a particular time has elapsed since the last abnormality notification, the downstream-side communication time function learning part 36 may determine that the abnormality has been resolved, and may learn a downstream-side communication time function without taking any additional downstream-side communication time into account.

The abnormality detection part 41 is a functional part that detects an abnormality (packet congestion, delay or the like) in itself (corresponding relay apparatus among 30A to 30Z) (see FIG. 13). The abnormality detection part 41 measures a total capacity value of the data packets stored in the packet buffer part 33 of itself (relay apparatus) (monitoring; the number of packets may also be measured). The abnormality detection part 41 determines whether or not the measured total capacity value (or the number of packets) exceeds a preset reference total capacity value (or the number of reference packets). If it determines that it exceeds, the abnormality detection part 41 determines that an abnormality has occurred in itself (relay apparatus) and generates an abnormality notification packet. An abnormality notification packet generated by the abnormality detection part 41 includes, of all the configuration data of the abnormality notification packet in FIG. 16, a destination relay apparatus address, an abnormal relay apparatus address, a downstream-side relay apparatus address (or a reception apparatus address), an expiration period, and an additional downstream-side communication time. The abnormality detection part 41 includes the address of a relay apparatus connected upstream-side of and adjacent to itself (relay apparatus) (corresponding relay apparatus among 30A to 30Y) in the abnormality notification packet as the destination relay apparatus address, which is the destination of the abnormality notification packet. The abnormality detection part 41 includes the address of itself (relay apparatus) in the abnormality notification packet as the abnormal relay apparatus address to identify the relay apparatus in which the abnormality has occurred. The abnormality detection part 41 includes the address of a relay apparatus connected downstream-side of and to adjacent itself (relay apparatus) (corresponding relay apparatus among 30B to 30Z; or reception apparatus) in the abnormality notification packet as the downstream-side relay apparatus address (or the reception apparatus address) to identify the relay apparatus connected downstream-side of the relay apparatus in which the abnormality has occurred. The abnormality detection part 41 causes the expiration period calculation part 42 to calculate an expiration period, and includes the calculated expiration period in the abnormality notification packet. The abnormality detection part 41 includes the calculated expiration period (initial value) in the abnormality notification packet as the additional downstream-side communication time. The abnormality detection part 41 transmits the generated abnormality notification packet to the relay apparatus (corresponding relay apparatus among 30A to 30Y) specified by the destination relay apparatus address i n the abnormality notification packet via the transmission part 34.

In addition to detecting an abnormality in itself (corresponding relay apparatus among 30A to 30Z), the abnormality detection part 41 detects an abnormality (packet congestion or the like) in a relay apparatus (corresponding relay apparatus among 30B to 30Z) connected downstream-side of itself (relay apparatus). By receiving an abnormality notification packet from a relay apparatus (corresponding relay apparatus among 30B to 30Z) connected downstream-side of and adjacent to itself (relay apparatus) via the reception part 32, the abnormality detection part 41 detects an abnormality in a relay apparatus (corresponding relay apparatus among 30B to 30Z) according to the abnormal relay apparatus address in the abnormality notification packet. When receiving the abnormality notification packet, the reception part 32 acquires the time (the current time) from the time synchronization part 31 and records the acquired time as the reception time of itself (corresponding relay apparatus among 30A to 30Y). As illustrated in FIG. 16, the abnormality notification packet received by the abnormality detection part 41 includes a destination relay apparatus address, an abnormal relay apparatus address, a downstream-side relay apparatus address (or a reception apparatus address), an expiration period, an additional downstream-side communication time, and a relay apparatus/reception time. Upon detection of an abnormality, the abnormality detection part 41 registers the additional downstream-side communication time in the received abnormality notification packet in the downstream-side communication time function learning part 36. The additional downstream-side communication time is used by the downstream-side communication time function learning part corresponding downstream-side communication time function. After registering the additional downstream-side communication time, the abnormality detection part 41 causes the expiration period calculation part 42 to calculate an expiration period, and determines whether or not the calculated expiration period is 0 or greater. If the expiration period is less than 0, the abnormality detection part 41 discards the abnormality notification packet. If the expiration period is 0 or greater, the abnormality detection part 41 updates the abnormality notification packet. When updating the abnormality notification packet, the abnormality detection part 41 rewrites the existing expiration period in the abnormality notification packet to the calculated new expiration period. In addition, when updating the abnormality notification packet, the abnormality detection part 41 rewrites the content of the destination relay apparatus address in the abnormality notification packet to the address of the relay apparatus (corresponding relay apparatus among 30A to 30Y) connected upstream-side of and adjacent to itself (relay apparatus). The abnormality detection part 41 transmits the updated abnormality notification packet to the relay apparatus (corresponding relay apparatus among 30A to 30Y) specified by the destination relay apparatus address in the abnormality notification packet via the transmission part 34.

The expiration period calculation part 42 is a functional part that calculates an expiration period to be included in an abnormality notification packet (see FIG. 13). For example, when the abnormality detection part 41 has detected an abnormality in itself (relay apparatus), the expiration period calculation part 42 may calculate an expiration period by calculating the difference between the total capacity value measured by the abnormality detection part 41 and a preset reference total capacity value and by dividing the calculated total capacity value difference by a preset reference transmission rate. The reference total capacity value corresponds to an average total capacity value of data packets normally stored in the packet buffer part 33 of itself (relay apparatus). The reference transmission rate corresponds to an average transmission rate when a data packet stored in the packet buffer part 33 of itself (relay apparatus) is normally transmitted.

When the abnormality detection part 41 detects an abnormality in a relay apparatus (corresponding relay apparatus among 30B to 30Z) connected downstream-side of itself (relay apparatus), the expiration period calculation part 42 calculates a new expiration period by subtracting the communication time between itself (relay apparatus) and the relay apparatus connected upstream-side of and adjacent to itself (relay apparatus) (corresponding to a value obtained by subtracting the transmission time of the relay apparatus connected upstream-side of and adjacent to itself from the reception time of itself) from the existing expiration period in the abnormality notification packet received by the abnormality detection part 41.

The time synchronization part 21 in each of the reception apparatuses 20A to 20M synchronizes the time of itself (reception apparatus) with each time of the transmission apparatuses 10A to 10L and the relay apparatuses 30A to 30Z. The reception part 22 in each of the reception apparatuses 20A to 20M receives a data packet from a relay apparatus 30, records (writes) the reception apparatus address/reception time of itself (reception apparatus) in the data packet, and outputs the data packet in which the reception apparatus address/reception time has been recorded to the packet storage part 23. As illustrated in FIG. 14, the data packet received by the reception part 22 includes a transmission apparatus address, a reception apparatus address, divided data, a packet type, a capacity value, an initial deadline, a transmission apparatus address/transmission time, a relay apparatus address/reception time, a relay apparatus address/transmission time, and a reception apparatus address/reception time. Regarding the relay apparatus address/reception time and the relay apparatus address/transmission time, the relay apparatus address/reception time and the relay apparatus address/transmission time of each of the relevant relay apparatuses 30A to 30Z through which the data packet has been transmitted are included. The downstream-side communication information generation part 24 in each of the reception apparatuses 20A to 20M generates, based on a data packet stored in the packet storage part 23, a downstream-side communication information packet relating to the communication of downstream-side (reception apparatus side) of the relay apparatus 30A adjacent to the transmission apparatuses (10A to 10L), and outputs the generated downstream-side communication information packet to the transmission part 25. As illustrated in FIG. 15, for example, the downstream-side communication information packet may include the capacity value, the relay apparatus address/reception time of each of relay apparatuses 30A to 30Z through which through which the data packet has been transmitted, and the reception apparatus address/reception time.

The transmission part 25 in each of the reception apparatuses 20A to 20M transmits a downstream-side communication information packet generated by the downstream-side communication information generation part 24 toward the relay apparatus 30Z.

Other aspects in configuration are the same as those in mode 1 (see FIG. 1).

An operation of a relay apparatus in a communication system according to mode 2 will be described.

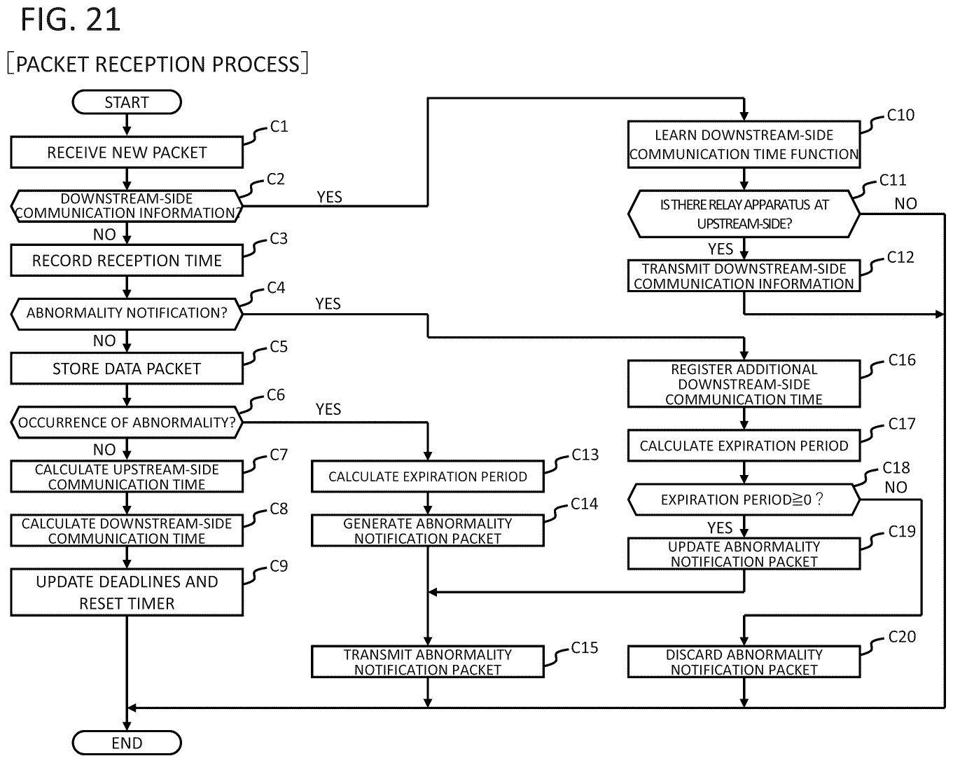

First, an operation relating to a packet reception process of a relay apparatus in a communication system according to mode 2 will be described with reference to drawings. FIG. 21 is a flowchart schematically illustrating an operation relating to a packet reception process of a relay apparatus in the second example of the configuration of the communication system according to the present disclosure. The communication system has the configuration illustrated in FIG. 13.

First, the reception part 32 in a relay apparatus (herein, the relay apparatus 30N) receives a new data packet from a relay apparatus (herein, the relay apparatus 30M) connected upstream-side of and adjacent to itself (relay apparatus 30N) or a new downstream-side communication information packet (see FIG. 15) or an abnormality notification packet (see FIG. 16) from a relay apparatus (herein, the relay apparatus 30O) connected downstream-side of and adjacent to itself (relay apparatus 30N) (step C1).

Next, the reception part 32 determines whether or not the received packet is a downstream-side communication information packet (step C2). If the received packet is a downstream-side communication information packet (YES in step C2), the process proceeds to step C10.

If the received packet is not a downstream-side communication information packet (NO in step C2; if the received packet is a data packet or an abnormality notification packet), the reception part 32 records (writes) the relay apparatus address/reception time of itself (relay apparatus 30M) in the data packet or the abnormality notification packet (step C3).

Next, the reception part 32 determines whether or not the received packet is an abnormality notification packet (step C4). If the received packet is an abnormality notification packet (YES in step C4), the process proceeds to step C16.

If the received packet is not an abnormality notification packet (NO in step C4; if the received packet is a data packet), the packet buffer part 33 in the relay apparatus 30N acquires the data packet in which the relay apparatus address/reception time has been recorded from the reception part 32 and stores the data packet (step C5).

Next, the abnormality detection part 41 in the relay apparatus 30N measures the total capacity value of data packets stored in the packet buffer part 33 of itself (relay apparatus 30N) (monitoring; may also measure the number of packets), and determines whether or not an abnormality has occurred in itself (relay apparatus 30N) by determining whether or not the measured total capacity value (or the number of packets) exceeds a preset reference total capacity value (or a preset reference packet number) (step C6). If an abnormality has occurred (YES in step C6), the process proceeds to step C13.

If an abnormality has not occurred (NO in step C6), the upstream-side communication time calculation part in the relay apparatus 30N refers to the data in the latest data packet stored in the packet buffer part 33 and calculates the upstream-side communication time by calculating the difference between the reception time of the relay apparatus 30N and the transmission time of the reception apparatus (for example, the transmission apparatus 10A) (step C7).

Next, the downstream-side communication time calculation part 37 in the relay apparatus 30N assigns the capacity value in the latest data packet stored in the packet buffer part 33 to the downstream-side communication time function stored in the downstream-side communication time function learning part 36, so as to calculate the downstream-side communication time of the data packet (step C8). Step C8 may be executed before step C7 or simultaneously with step C7.

Next, the deadline management part 38 in the relay apparatus 30N updates (calculates) the deadline of the individual data packet stored in the packet buffer part 33, and resets the timer part 39 to 0 (step C9). Next, the process proceeds to END and returns to START.

Regarding the updating of the deadline, the deadline of the latest data packet stored in the packet buffer part 33 is calculated and stored, and the deadline of the individual existing data packet stored in the packet buffer part 33 is updated (the timer count value of the timer part 39 is subtracted from the individual deadline previously updated). After resetting the timer count value, the timer part 39 continues its counting.

If the received packet is a downstream-side communication information packet (YES in step C2), the downstream-side communication time function learning part 36 in the relay apparatus 30N acquires the downstream-side communication information packet from the reception part 32, and learns a downstream-side communication time function by using the data in the acquired downstream-side communication information packet (which may include the latest and/or an existing downstream-side communication information packet) (step C10).

Next, when storing the latest downstream-side communication information packet, the downstream-side communication time function learning part 36 determines whether or not there is a relay apparatus connected upstream-side of itself (relay apparatus 30N) (step C11). If there is no relay apparatus connected upstream-side of itself (relay apparatus 30N) (NO in step C11), and the process proceeds to END and returns to START.

If there is a relay apparatus connected upstream-side of itself (relay apparatus 30N) (YES in step C11), the downstream-side communication time function learning part 36 transmits the latest downstream-side communication information packet to the relay apparatus 30M connected upstream-side of and adjacent to itself (relay apparatus 30N) via the transmission part 34 (step C12), and the process proceeds to END and returns to START.

If an abnormality has occurred (YES in step C6), the abnormality detection part 41 in the relay apparatus 30N causes the expiration period calculation part 42 to calculate an expiration period (step C13).

Next, the abnormality detection part 41 generates an abnormality notification packet including the calculated expiration period (step C14). When generating the abnormality notification packet, the abnormality detection part 41 includes the address of the relay apparatus 30M connected upstream-side of and adjacent to itself (relay apparatus 30N) in the abnormality notification packet as the destination relay apparatus address, includes the address of itself (relay apparatus 30N) in the abnormality notification packet as the abnormal relay apparatus address, includes the address o f the relay apparatus 30O connected downstream-side of and adjacent to itself (relay apparatus 30N) in the abnormality notification packet as the downstream-side relay apparatus address, includes the calculated expiration period in the abnormality notification packet, and includes the calculated expiration period (initial value) in the abnormality notification packet as the additional downstream-side communication time. There are cases in which the expiration period (initial value) does not match the additional downstream-side communication time. However, even in these cases, because the expiration period (initial value) approximates the additional downstream-side communication time, the expiration period (initial value) is treated as the additional downstream-side communication time.

After step C14 or after step C19, the abnormality detection part 41 transmits the generated abnormality notification packet to the relay apparatus 30M according to the destination relay apparatus address in the abnormality notification packet via the transmission part 34 (step C15), and the process proceeds to END and returns to START.

If the received packet i an abnormality notification packet (YES in step C4), the abnormality detection part 41 in the relay apparatus 30N registers the additional downstream-side communication time in the received abnormality notification packet in the downstream-side communication time function learning part 36 (step C16).

Next, the abnormality detection part 41 causes the expiration period calculation part 42 to calculate an expiration period (step C17). Regarding the calculation of the expiration period, a new expiration period is calculated by subtracting the communication time between itself (relay apparatus) and the relay apparatus connected upstream-side thereof and adjacent thereto from the existing expiration period in the received abnormality notification packet (corresponding to a value obtained by subtracting the transmission time of the relay apparatus connected upstream-side thereof and adjacent thereto from the reception time of itself (relay apparatus)).

Next, the abnormality detection part 41 determines whether or not the calculated new expiration period is 0 or greater (step C18). If the new expiration period is less than 0 (NO in step C18), the process proceeds to step C20.

If the new expiration period is 0 or greater (YES in step C18), the abnormality detection part 41 updates the abnormality notification packet by rewriting the existing expiration period in the abnormality notification packet to the calculated new expiration period (step C19). After step C19, the process proceeds to step C15.

If the new expiration period is less than 0 (NO in step C18), the abnormality detection part 41 discards the abnormality notification packet (step C20), and the process proceeds to END and returns to START.

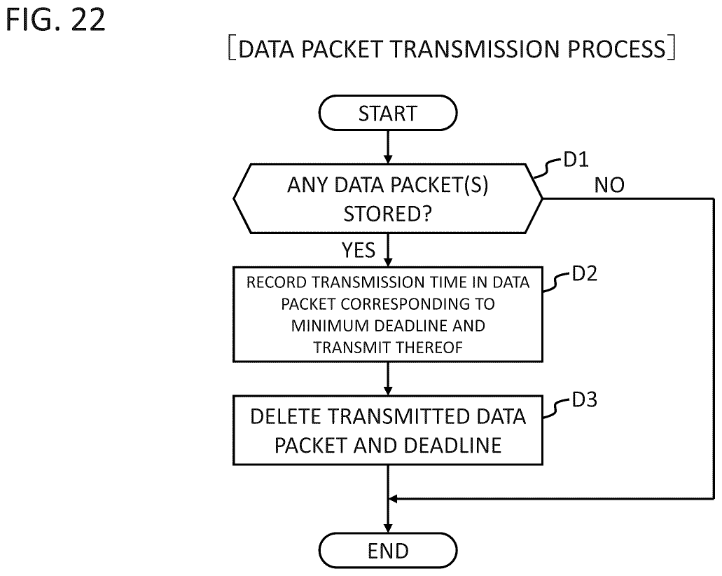

Next, an operation relating to a packet transmission process of a relay apparatus in the communication system according to mode 2 will be described with reference to drawings. FIG. 22 is a flowchart schematically illustrating an operation to relating a packet transmission process of a relay apparatus in the second example of the configuration of the communication system according to the present disclosure. The communication system has the configuration illustrated in FIG. 13.

First, the packet buffer part 33 in the relay apparatus 30N determines whether or not a data packet is stored in itself (relay apparatus 30N) (step D1). If there is no stored data packet (NO in step D1), the process proceeds to END and returns to START.

If there is a stored data packet (YES in step D1), the transmission part 34 in the relay apparatus 30N acquires a data packet corresponding to the minimum value of deadline in the deadline management part 38 from the packet buffer part 33, records (writes) the relay apparatus address/transmission time of itself (relay apparatus 30N) in the acquired data packet, and transmits the data packet in which the relay apparatus address/transmission time has been recorded to the relay apparatus 30O (the relay apparatus disposed on the communication path to the reception apparatus according to the reception apparatus address in the data packet) (step D2).

Next, the packet buffer part 33 deletes the transmitted data packet, and the deadline management part 38 deletes the deadline in the transmitted data packet (step D3). Next, the process proceeds to END and returns to START.

According to mode 2, as in mode 1, by taking into account the retention time and the communication time of the packet inside and outside the relay apparatus 30, the packet relay processing can be accurately controlled to communicate each packet within an appropriate time (deadline). When an abnormality (delay, congestion, or the like) occurs in any of the relay apparatus 30A to 30Z due to an input of a jumbo packet (a packet with a large capacity value) or an intensive input of a large number of packets thereto, a content of the abnormality (an expiration period and an additional downstream-side communication time) that occurred during the relay process is notified to the relay apparatus connected upstream-side thereof. Thus, the content of the abnormality is also taken into account in the relay processing of packets, so that each packet can be communicated more reliably within the deadline.

In addition, according to mode 2, the range of notification of the content of the abnormality that has occurred in the relay process is limited. This makes it possible to limit the number of notifications even when there are many relay processes to be notified, thus avoiding communication tightness.

### [Mode 3]

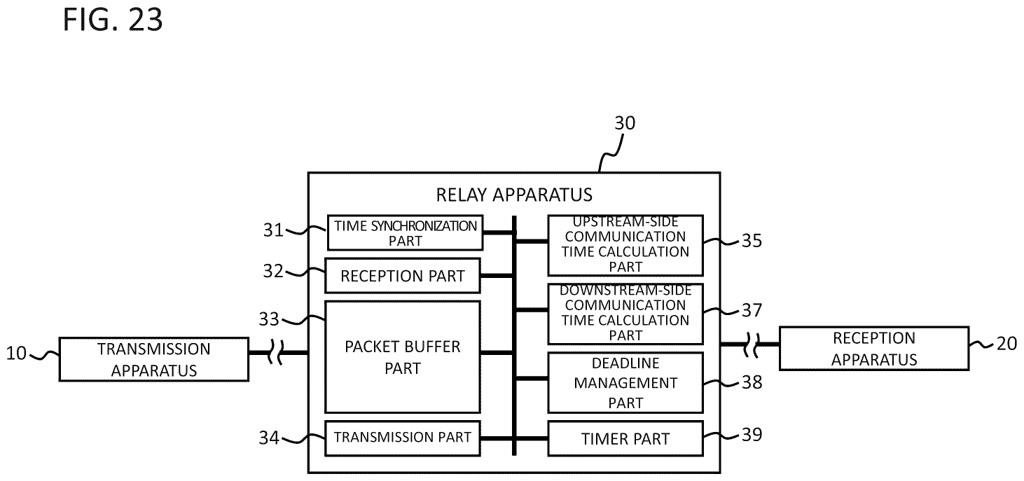

A relay apparatus according to mode 3 will be described with reference to drawings. FIG. 23 is a block diagram schematically illustrating an example of a configuration of a relay apparatus according to the present disclosure.

A relay apparatus 30 is configured to relay data packets from a transmission apparatus 10 to a reception apparatus 20. The relay apparatus 30 is provided with a time synchronization part 31, a reception part 32, a packet buffer part 33, an upstream-side communication time calculation part 35, a downstream-side communication time calculation part 37, a timer part 39, a deadline management part 38, and a transmission part 34.

The time synchronization part 31 is configured to synchronize the time of the relay apparatus 30 itself with each time of each of the transmission apparatus 10 and the reception apparatus 20. The reception part 32 is configured to receive the data packet from the transmission apparatus 10 and to record the reception time of the data packet by the relay apparatus 30 itself in the data packet based on the time synchronized by the time synchronization part 31. The packet buffer part 33 is configured to store the data packet from the reception part 32. The upstream-side communication time calculation part 35 is configured to calculate the upstream-side communication time from the transmission apparatus 10 to the relay apparatus 30 by subtracting the transmission time of the data packet of the transmission apparatus 10 included in the data packet stored in the packet buffer part 33, from the reception time recorded in the data packet. The downstream-side communication time calculation part 37 is configured to calculate, based on a downstream-side communication time function for calculating the downstream-side communication time from the relay apparatus 30 to the reception apparatus by using a packet capacity value as a variable and based on the capacity value included in the data packet stored in the packet buffer part 33, the downstream-side communication time from the relay apparatus 30 to the reception apparatus 20. The timer part 39 is configured to count the retention time of the data packet in the packet buffer part 33, the data packet being stored in the packet buffer part 33. The deadline management part 38 is configured to calculate the deadline of the data packet stored in the packet buffer part 33 by subtracting, from the initial deadline included in the data packet stored in the packet buffer part 33, the upstream-side communication time calculated by the upstream-side communication time calculation part, the downstream-side communication time calculated by the downstream-side communication time calculation part, and the retention time counted by the timer part. The transmission part 34 is configured to transmit, with highest priority, of all the data packets stored in the packet buffer part 33, a data packet having the minimum value of the deadline calculated by the deadline management part to the reception apparatus 20.

According to mode 3, the relay apparatus 30 transmits (outputs), with highest priority, a data packet having the minimum value of deadline of all the deadlines, each of which has been calculated by using an upstream-side communication time, which is the data packet communication time the transmission from apparatus 10 to the relay apparatus 30, a downstream-side communication time, which is the data packet communication time from the relay apparatus 30 to the reception apparatus 20, and a data packet retention time in the relay apparatus 30. Therefore, by taking into account the retention time and the communication time of the packet inside and outside the relay apparatus 30, the packet relay processing can be accurately controlled to communicate each packet within an appropriate time (deadline).

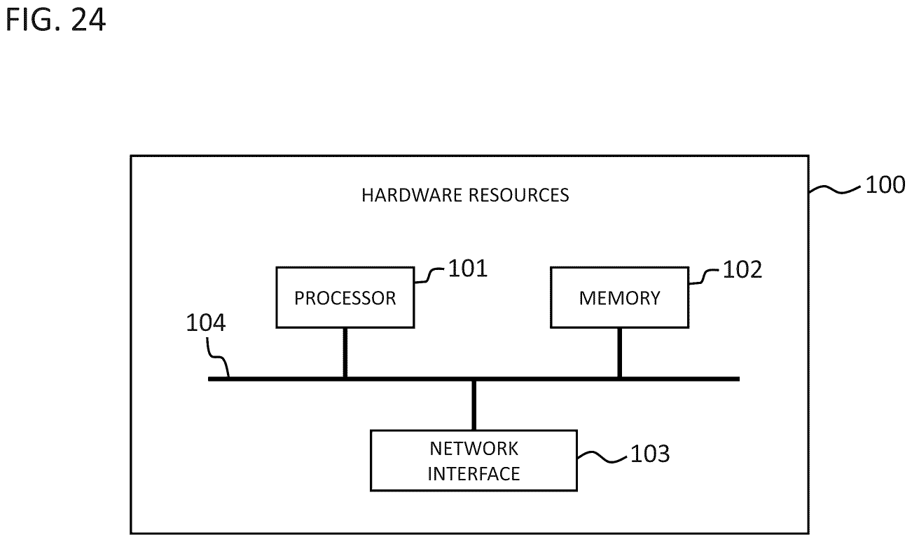

The transmission apparatuses, the relay apparatuses, and the reception apparatuses according to mode 1 to mode 3 can be configured with so-called hardware resources (an information processing apparatus, a computer), and those with a configuration exemplified in FIG. 24 can be used. For example, a hardware resource 100 is provided with a processor 101, a memory 102, a network interface 103, etc., which are connected to each other by an internal bus 104.

The configuration illustrated in FIG. 24 is not intended to limit the hardware configuration of the hardware resource 100. The hardware resources 100 may include hardware not illustrated (for example, an input-output interface). Alternatively, the number of units such as processor 101 included in the apparatus is not intended to be limited to the example illustrated in FIG. 24. For example, a plurality of processors 101 may be included in the hardware resources 100. For example, a CPU (Central Processing Unit), an MPU (Micro Processor Unit), or a GPU (Graphics Processing Unit) may be used as the processor 101.

For example, a RAM (Random Access Memory), a ROM (Read-Only Memory), an HDD (Hard Disk Drive), or an SSD (Solid State Drive) may be used as the memory 102.

For example, a LAN (Local Area Network) card, a network adapter, or a network interface card may be used as the network interface 103.

The functions of the hardware resource 100 are realized by the above-described processing modules. The processing modules are realized by causing the processor 101 to execute a program stored in the memory 102, for example. This program may be updated by downloading a program update via a network or by using a storage medium holding a program update. In addition, the above-described processing modules may be realized by semiconductor chips. That is, the functions executed by the above-described processing modules are realized by executing software on some hardware.

A part or a whole of the above-mentioned modes may be described as, but not limited to, the following supplementary notes (Notes).

### [Note 1]

A relay apparatus configured to relay a data packet from a transmission apparatus to a reception apparatus, the relay apparatus includes:
a time synchronization part configured to synchronize a time of the relay apparatus with a time of the transmission apparatus and a time of the reception apparatus;
a reception part configured to receive the data packet from the transmission apparatus and to record a reception time of the data packet at the relay apparatus in the data packet based on the time synchronized by the time synchronization part;
a packet buffer part configured to store the data packet from the reception part;
an upstream-side communication time calculation part configured to calculate an upstream-side communication time from the transmission apparatus to the relay apparatus by subtracting a transmission time of the data packet at the transmission apparatus from the reception time recorded in the data packet, the transmission time being included in the data packet stored in the packet buffer part;
a downstream-side communication time calculation part configured to calculate a downstream-side communication time from the relay apparatus to the reception apparatus, based on a downstream-side communication time function for calculating a downstream-side communication time from the relay apparatus to the reception apparatus and a capacity value included in the data packet stored in the packet buffer part, the downstream-side communication time function being a packet capacity value as a variable;
a timer part configured to count a retention time of the data packet in the packet buffer part, the data packet being stored in the packet buffer part;
a deadline management part configured to calculate a deadline of the data packet stored in the packet buffer part by subtracting, from an initial deadline included in the data packet stored in the packet buffer part, the upstream-side communication time calculated by the upstream-side communication time calculation part, the downstream-side communication time calculated by the downstream-side communication time calculation part, and the retention time counted by the timer part; and a transmission part configured to transmit, with a highest priority, a data packet corresponding to a minimum value of the deadline calculated by the deadline management part among data packets stored in the packet buffer part, to the reception apparatus.

### [Note 2]

The relay apparatus described in Note 1, further includes:
a downstream-side communication time function learning part configured to acquire a downstream-side communication information packet transmitted from the reception apparatus and including the downstream-side communication time of a past and the capacity value, and to learn the downstream-side communication time function based on the downstream-side communication information packet acquired;
wherein the downstream-side communication time calculation part is configured to calculate the downstream-side communication time using the downstream-side communication time function learned by the downstream-side communication time function learning part.

### [Note 3]

In the relay apparatus described in Note 2,
the downstream-side communication time function learning part is configured to create a scatter diagram in which points, which indicate the downstream-side communication time and the capacity value for the individual downstream-side communication information packet, are plotted in a graph in which a X axis represents capacity value and a Y axis represents downstream-side communication time, to create a regression line based on the scatter diagram created, and to learn the downstream-side communication time function based on the regression line created.

### [Note 4]

In the relay apparatus described in any one of Notes 1 to 3,
the initial deadline is set by the transmission apparatus according to the packet type or the capacity value of the data packet.

### [Note 5]

In the relay apparatus described in any one of Notes 1 to 4,
the deadline management part is configured to, when a new data packet is inputted to and stored in the packet buffer part, calculate and store a deadline of the new data packet, and perform a recalculation of the deadline of an existing data packet stored in the packet buffer part.

### [Note 6]

In the relay apparatus described in Note 5;
the timer part is configured to be reset to 0 when the new data packet is inputted to and stored in the packet buffer part; and
the deadline management part is configured to recalculate the deadline of the existing data packet stored in the packet buffer part by subtracting a timer count value immediately before the timer part is reset to 0 from the deadline immediately before the recalculation.

### [Note 7]

In the relay apparatus described in Note 5 or 6;
the packet buffer part is configured to delete, when the data packet is transmitted from the transmission part, the data packet transmitted, from the packet buffer part; and
the deadline management part is configured to delete, when the data packet is transmitted from the transmission part, the deadline corresponding to the data packet transmitted.

### [Note 8]

The relay apparatus described in Note 2 or 3, further includes:
an abnormality detection part configured to detect an abnormality of the relay apparatus by measuring a total capacity value of the data packet(s) stored in the packet buffer part of the relay apparatus and determining whether or not the total capacity value measured exceeds a reference total capacity value set in advance; and an expiration period calculation part configured to calculate an expiration period using the total capacity value measured by the abnormality detection part when an abnormality of the relay apparatus is detected;
wherein the abnormality detection part is configured to, when an abnormality of the relay apparatus is detected, generate an abnormality notification packet including the expiration period calculated by the expiration period calculation part as an additional downstream-side communication time and transmit the abnormality notification packet generated to an upstream-side relay apparatus disposed on a communication path between the relay apparatus and the transmission apparatus;
wherein the abnormality detection part is configured to detect, by receiving another abnormality notification packet similar to the abnormality notification packet from a downstream-side relay apparatus disposed on the communication path between the relay apparatus and the reception apparatus, an abnormality of the downstream-side relay apparatus, and to register another additional downstream-side communication time, included in the another abnormality notification packet and being similar to the additional downstream-side communication time, in the downstream-side communication time function learning part; and
wherein the downstream-side communication time function learning part is configured to learn the downstream-side communication time function using the another additional downstream-side communication time registered.

### [Note 9]

In the relay apparatus described in Note 8;
the expiration period calculation part is configured to calculate, when an abnormality of the relay apparatus is detected, an expiration period by calculating a difference between the total capacity value measured by the abnormality detection part and the reference total capacity value set in advance and by dividing the difference calculated by a reference transmission rate set in advance.

### [Note 10]

In the relay apparatus described in Note 8 or 9;
the abnormality detection part is configured to generate, when an abnormality of the relay apparatus is detected, the abnormality notification packet including the expiration period and the additional downstream-side communication time;
the expiration period calculation part is configured to calculate, when receiving the another abnormality notification packet and detecting an abnormality of the downstream-side relay apparatus, a new another expiration period by subtracting, from an existing another expiration period included in the another abnormality notification packet and being similar to the expiration period, the communication time between the relay apparatus and an adjacent relay apparatus disposed on an upstream-side of the relay apparatus; and the abnormality detection part is configured to determine, when an abnormality of the downstream-side relay apparatus is detected, whether or not the new another expiration period calculated by the expiration period calculation part is 0 or greater, and is configured to discard the another abnormality notification packet when the new another expiration period is less than 0 and to rewrite the existing another expiration period in the another abnormality notification packet to the new another expiration period when the new another expiration period is 0 or greater, to transmit the rewritten another abnormality notification packet to the upstream-side relay apparatus. [Note 11]

A communication system includes:
at least one of the relay apparatuses according to any one of claims 1 to 7;
at least one of the transmission apparatuses configured to generate and transmit the data packet to the relay apparatus; and
the reception apparatus configured to receive the data packet from the transmission apparatus via the relay apparatus and to store the data packet.

### [Note 12]

In the communication system described in Note 11;
the transmission apparatus includes a time synchronization part that is configured to synchronize a time of the transmission apparatus with a time of the relay apparatus and a time of the reception apparatus and to use the time synchronized as a transmission time; and the reception apparatus includes a time synchronization part that is configured to synchronize a time of the reception apparatus with a time of the transmission apparatus and a time of the relay apparatus and to use the time synchronized as a reception time.

### [Note 13]

A communication control method, that controls communication by using a relay apparatus that relays a data packet from a transmission apparatus to a reception apparatus, the communication control method includes:
a step of synchronizing a time of the relay apparatus with a time of the transmission apparatus and a time of the reception apparatus;
a step of receiving the data packet from the transmission apparatus and recording a reception time of the data packet at the relay apparatus in the data packet based on the time synchronized;
a step of storing the data packet in which the reception time has been recorded;
a step of calculating an upstream-side communication time from the transmission apparatus to the relay apparatus by subtracting a transmission time of the data packet at the transmission apparatus from the reception time recorded in the data packet, the transmission time being included in the data packet stored;
a step of calculating a downstream-side communication time from the relay apparatus to the reception apparatus, based on a downstream-side communication time function for calculating a downstream-side communication time from the relay apparatus to the reception apparatus and a capacity value included in the data packet stored, the downstream-side communication time function being a packet capacity value as a variable
a step of counting a retention time of the data packet stored;
a step of calculating a deadline of the data packet stored by subtracting, from an initial deadline included in the data packet stored, the upstream-side communication time calculated, the downstream-side communication time calculated, and the retention time counted; and a step of transmitting, a highest priority, a data packet corresponding to a minimum value of the deadline calculated among data packets stored, to the reception apparatus.

### [Note 14]

The communication control method described in Note 13, further includes:
a step of acquiring a downstream-side communication information packet transmitted from the reception apparatus and including the downstream-side communication time of a past and the capacity value;
a step of learning the downstream-side communication time function based o n the downstream-side communication information packet acquired;
a step of measuring a total capacity value of the data packet stored in the relay apparatus;
a step of detecting an abnormality of the relay apparatus by determining whether or not the total capacity value measured exceeds a reference total capacity value set in advance;
a step of calculating an expiration period by using the total capacity value measured when an abnormality of the relay apparatus is detected;
a step of generating an abnormality notification packet including expiration period calculated as a n additional downstream-side communication time;
a step of transmitting the abnormality notification packet generated to an upstream-side relay apparatus disposed on a communication path between the relay apparatus and the transmission apparatus;
a step of detecting, by receiving another abnormality notification packet similar to the abnormality notification packet transmitted from a downstream-side relay apparatus disposed on the communication path between the relay apparatus and the reception apparatus, an abnormality of the downstream-side relay apparatus, and registering another additional downstream-side communication time included in the another abnormality notification packet and being similar to the additional downstream-side communication time; and
a step of learning the downstream-side communication time function using the another additional downstream-side communication time registered;
wherein in the step of calculating the downstream-side communication time, the downstream-side communication time is calculated using the downstream-side communication time function learned.

### [Note 15]

A communication control method, that controls communication by a relay apparatus that relays a data packet from a transmission apparatus to a reception apparatus, the communication control method includes: a step of calculating a downstream-side communication time, which is a communication time on a communication path between the relay apparatus and the reception apparatus;
a step of measuring a total capacity value of the data packet stored in the relay apparatus;
a step of detecting an abnormality of the relay apparatus by determining whether or not the total capacity value measured exceeds a reference total capacity value set in advance; and
a step of calculating an expiration period using the total capacity value measured when an abnormality of the relay apparatus is detected;
a step of generating an abnormality notification packet including the expiration period calculated as an additional downstream-side communication time; and a step of transmitting the abnormality notification packet generated, to an upstream-side relay apparatus disposed on a communication path between the relay apparatus and the transmission apparatus;
wherein when the downstream-side communication time is calculated, by receiving another abnormality notification packet similar to the abnormality notification packet from a downstream-side relay apparatus disposed on the communication path between the relay apparatus and the reception apparatus, an abnormality of the downstream-side relay apparatus is detected, and the downstream-side communication time is extended based on the additional downstream-side communication time included in the another abnormality notification packet.

### [Note 16]

A program, executed by a relay apparatus that relays a data packet from a transmission apparatus to a reception apparatus, the program causes the relay apparatus to execute:
a process for synchronizing a time of the relay apparatus with a time of the transmission apparatus and a time of the reception apparatus;
a process for receiving the data packet from the transmission apparatus and recording a reception time of the data packet at the relay apparatus in the data packet based on the time synchronized;
a process for storing the data packet in which the reception time has been recorded;
a process for calculating an upstream-side communication time from the transmission apparatus to the relay apparatus by subtracting a transmission time of the data packet at the transmission apparatus from the reception time recorded in the data packet, the transmission time being included in the data packet stored;
a process for calculating a downstream-side communication time from the relay apparatus to the reception apparatus, based on a downstream-side communication time function for calculating a downstream-side communication time from the relay apparatus to the reception apparatus and a capacity value included in the data packet stored, the downstream-side communication time function being a packet capacity value as a variable
a process for counting a retention time of the data packet stored;
a process for calculating a deadline of the data packet stored by subtracting, from an initial deadline included in the data packet stored, the upstream-side communication time calculated, the downstream-side communication time calculated, and the retention time counted; and
a process for transmitting, with the highest priority, a data packet corresponding to a minimum value of the deadline calculated of data packet(s) stored, to the reception apparatus.

### [Note 17]

In the program described in Note 16:
the program causes the relay apparatus to execute a process for acquiring a downstream-side communication information packet transmitted from the reception apparatus and including the downstream-side communication time of past and the capacity value;
a learning the downstream-side process for communication time function based on the downstream-side communication information packet acquired;
a process for measuring a total capacity value of the data packet stored in the relay apparatus;
a process for detecting an abnormality of the relay apparatus by determining whether or not the total capacity value measured exceeds a reference total capacity value set in advance;
a process for calculating an expiration period by using the total capacity value measured when an abnormality of the relay apparatus is detected;
a process for generating an abnormality notification packet including the expiration period calculated as an additional downstream-side communication time;
a process for transmitting the abnormality notification packet generated to an upstream-side relay apparatus disposed on a communication path between the relay apparatus and the transmission apparatus;
a process for detecting, by receiving another abnormality notification packet similar to the abnormality notification packet transmitted from a downstream-side relay apparatus disposed on the communication path between the relay apparatus and the reception apparatus, an abnormality of the downstream-side relay apparatus, and registering another additional downstream-side communication time included in the another abnormality notification packet and being similar to the additional downstream-side communication time; and
a process for learning the downstream-side communication time function using the another additional downstream-side communication time registered;
wherein in the process for calculating the downstream-side communication time, the downstream-side communication time is calculated using the downstream-side communication time function learned.

### [Note 18]

A program, executed by a relay apparatus that relays a data packet from a transmission apparatus to a reception apparatus, the program causes the relay apparatus to execute:
a process for calculating a downstream-side communication time, which is a communication time on a communication path between the relay apparatus and the reception apparatus;
a process for measuring a total capacity value of the data packet stored in the relay apparatus;
a process for detecting an abnormality of the relay apparatus by determining whether or not total capacity value measured exceeds a reference total capacity value set in advance; and a process for calculating an expiration period using the total capacity value measured when an abnormality of the relay apparatus is detected;
a process for generating an abnormality notification packet including the expiration period calculated as an additional downstream-side communication time; and a process for transmitting the abnormality notification packet generated, to an upstream-side relay apparatus disposed on a communication path between the relay apparatus and the transmission apparatus;
wherein when the downstream-side communication time is calculated, by receiving another abnormality notification packet similar to the abnormality notification packet from a downstream-side relay apparatus disposed on the communication path between the relay apparatus and the reception apparatus, an abnormality of the downstream-side relay apparatus is detected, and the downstream-side communication time is extended based on the additional downstream-side communication time included in the another abnormality notification packet.

The disclosure of PTL cited above is incorporated herein in its entirety by reference thereto, and can be used as a basis or a part of the present invention as needed. It is to be noted that it is possible to modify or adjust the example embodiments or examples within the scope of the whole disclosure of the present invention (including claims and drawings) and based on the basic technical concept thereof. Further, it is possible to variously combine or select (or partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein, even if the description does not clearly disclose arbitrary intermediate values, lower numerical values, or small ranges included in the ranges, these values and ranges should be deemed to have been disclosed. In addition, as needed and based on the gist of the present application of the present invention, partial or entire use of the individual disclosed matters in the above literature that has been referred to in combination with what is disclosed in the present application should be deemed to be included in (belong to) what is disclosed in the present application, as part of the disclosure of the present application of the present invention.

### REFERENCE SIGNS LIST

1: communication system
10, 10A to 10L: transmission apparatus
11: packet generation part
12: transmission part
13: time synchronization part
20, 20A to 20M: reception apparatus
21: time synchronization part
22: reception part
23: packet storage part
24: downstream-side communication information generation part
25: transmission part
30, 30A to 30Z: relay apparatus
31: time synchronization part
32: reception part
33: packet buffer part
34: transmission part
35: upstream-side communication time calculation part
36: downstream-side communication time function learning part
37: downstream-side communication time calculation part
38: deadline management part
39: timer part
41: abnormality detection part
42: expiration period calculation part
100: hardware resources
101: processor
102: memory
103: network interface
104: internal bus

What is claimed is:

1. A relay apparatus configured to relay a data packet from a transmission apparatus to a reception apparatus, the relay apparatus comprising:
at least a processor; and
a memory in circuit communication with the processor,
wherein the processor is configured to execute program instructions stored in the memory to implement:
a time synchronization part configured to synchronize a time of the relay apparatus with a time of the transmission apparatus and a time of the reception apparatus;
a reception part configured to receive the data packet from the transmission apparatus and to record a reception time of the data packet at the relay apparatus in the data packet based on the time synchronized by the time synchronization part;
a packet buffer part configured to store the data packet from the reception part;
an upstream-side communication time calculation part configured to calculate an upstream-side communication time from the transmission apparatus to the relay apparatus by subtracting a transmission time of the data packet at the transmission apparatus from the reception time recorded in the data packet, the transmission time being included in the data packet stored in the packet buffer part;
a downstream-side communication time calculation part configured to calculate a downstream-side communication time from the relay apparatus to the reception apparatus, based on a downstream-side communication time function for calculating a downstream-side communication time from the relay apparatus to the reception apparatus and a capacity value included in the data packet stored in the packet buffer part, the downstream-side communication time function being a packet capacity value as a variable;
a timer part configured to count a retention time of the data packet in the packet buffer part, the data packet being stored in the packet buffer part;
a deadline management part configured to calculate a deadline of the data packet stored in the packet buffer part by subtracting, from an initial deadline included in the data packet stored in the packet buffer part, the upstream-side communication time calculated by the upstream-side communication time calculation part, the downstream-side communication time calculated by the downstream-side communication time calculation part, and the retention time counted by the timer part; and
a transmission part configured to transmit, with a highest priority, a data packet corresponding to a minimum value of the deadline calculated by the deadline management part among data packets stored in the packet buffer part, to the reception apparatus.

2. The relay apparatus according to claim 1, wherein the processor is configured to execute program instructions stored in the memory to further implement:
a downstream-side communication time function learning part configured to acquire a downstream-side communication information packet transmitted from the reception apparatus and including the downstream-side communication time of a past and the capacity value, and to learn the downstream-side communication time function based on the downstream-side communication information packet acquired;
wherein the downstream-side communication time calculation part is configured to calculate the downstream-side communication time using the downstream-side communication time function learned by the downstream-side communication time function learning part.

3. The relay apparatus according to claim 2, wherein the downstream-side communication time function learning part is configured to create a scatter diagram in which points, which indicate the downstream-side communication time and the capacity value for the individual downstream-side communication information packet, are plotted in a graph in which a X axis represents capacity value and a Y axis represents downstream-side communication time, to create a regression line based on the scatter diagram created, and to learn the downstream-side communication time function based on the regression line created.

4. The relay apparatus according to claim 1; wherein the initial deadline is set by the transmission apparatus according to a packet type or the capacity value of the data packet.

2. The relay apparatus according to claim 1; wherein the deadline management part is configured to, when a new data packet is inputted to and stored in the packet buffer part, calculate and store a deadline of the new data packet, and perform a recalculation of the deadline of an existing data packet stored in the packet buffer part.

6. The relay apparatus according to claim 5;
wherein the timer part is configured to be reset to 0 when the new data packet is inputted to and stored in the packet buffer part; and
wherein, the deadline management part is configured to recalculate the deadline of the existing data packet stored in the packet buffer part by subtracting a timer count value immediately before the timer part is reset to 0 from the deadline immediately before the recalculation.

7. The relay apparatus according to claim 5;
wherein the packet buffer part is configured to delete, when the data packet is transmitted from the transmission part, the data packet transmitted, from the packet buffer part; and
wherein the deadline management part is configured to delete, when the data packet is transmitted from the transmission part, the deadline corresponding to the data packet transmitted.

8. The relay apparatus according to claim 2, wherein the processor is configured to execute program instructions stored in the memory to further implement:
an abnormality detection part configured to detect an abnormality of the relay apparatus by measuring a total capacity value of the data packet(s) stored in the packet buffer part of the relay apparatus and determining whether or not the total capacity value measured exceeds a reference total capacity value set in advance; and
an expiration period calculation part configured to calculate an expiration period using the total capacity value measured by the abnormality detection part when an abnormality of the relay apparatus is detected;
wherein the abnormality detection part is configured to, when an abnormality of the relay apparatus is detected, generate an abnormality notification packet including the expiration period calculated by the expiration period calculation part as an additional downstream-side communication time and transmit the abnormality notification packet generated to an upstream-side relay apparatus disposed on a communication path between the relay apparatus and the transmission apparatus;
wherein the abnormality detection part is configured to detect, by receiving another abnormality notification packet similar to the abnormality notification packet from a downstream-side relay apparatus disposed on the communication path between the relay apparatus and the reception apparatus, an abnormality of the downstream-side relay apparatus, and to register another additional downstream-side communication time, included in the another abnormality notification packet and being similar to the additional downstream-side communication time, in the downstream-side communication time function learning part; and
wherein the downstream-side communication time function learning part is configured to learn the downstream-side communication time function using the another additional downstream-side communication time registered.

9. The relay apparatus according to claim 8; wherein the expiration period calculation part is configured to calculate, when an abnormality of the relay apparatus is detected, an expiration period by calculating a difference between the total capacity value measured by the abnormality detection part and the reference total capacity value set in advance and by dividing the difference calculated by a reference transmission rate set in advance.

10. The relay apparatus according to claim 8;
wherein the abnormality detection part is configured to generate, when an abnormality of the relay apparatus is detected, the abnormality notification packet including the expiration period and the additional downstream-side communication time;
wherein the expiration period calculation part is configured to calculate, when receiving the another abnormality notification packet and detecting a n abnormality of the downstream-side relay apparatus, a new another expiration period by subtracting, from an existing another expiration period included in the another abnormality notification packet and being similar to the expiration period, the communication time between the relay apparatus and an adjacent relay apparatus disposed on an upstream-side of the relay apparatus; and
wherein the abnormality detection part is configured to determine, when an abnormality of the downstream-side relay apparatus is detected, whether or not the new another expiration period calculated by the expiration period calculation part is 0 or greater, and is configured to discard the another abnormality notification packet when the new another expiration period is less than 0 and to rewrite the existing another expiration period in the another abnormality notification packet to the new another expiration period when the new another expiration period is 0 or greater, to transmit the rewritten another abnormality notification packet to the upstream-side relay apparatus.

11. A communication system, comprising:
at least one of the relay apparatuses according to claim 1;
at least one of the transmission apparatuses, and
the reception apparatus,
wherein each of transmission apparatus comprises:
at least a processor; and
a memory in circuit communication with the processor,
wherein the processor is configured to execute program instructions stored in the memory to perform generating and transmitting the data packet to the relay apparatus; and
wherein the reception apparatus comprises:
at least a processor; and
a memory in circuit communication with the processor,
wherein the processor is configured to execute program instructions stored in the memory to perform the data packet from the transmission receiving apparatus via the relay apparatus and to store the data packet.

12. The communication system according to claim 11;
wherein the transmission apparatus includes a time synchronization part that is configured to synchronize a time of the transmission apparatus with a time of the relay apparatus and a time of the reception apparatus and to use the time synchronized as a transmission time; and
wherein the reception apparatus includes a time synchronization part that is configured to synchronize a time of the reception apparatus with a time of the transmission apparatus and a time of the relay apparatus and to use the time synchronized as a reception time.

13. A communication control method, that controls communication by a relay apparatus that relays a data packet from a transmission apparatus to a reception apparatus, the communication control method comprising:
synchronizing a time of the relay apparatus with a time of the transmission apparatus and a time of the reception apparatus;
receiving the data packet from the transmission apparatus and recording a reception time of the data packet at the relay apparatus in the data packet based on the time synchronized;
storing the data packet in which the reception time has been recorded;
calculating an upstream-side communication time from the transmission apparatus to the relay apparatus by subtracting a transmission time of the data packet at the transmission apparatus from the reception time recorded in the data packet, the transmission time being included in the data packet stored;
calculating a downstream-side communication time from the relay apparatus to the reception apparatus, based on a downstream-side communication time function for calculating a downstream-side communication time from the relay apparatus to the reception apparatus and a capacity value included in the data packet stored, the downstream-side communication time function being a packet capacity value as a variable
counting a retention time of the data packet stored;
calculating a deadline of the data packet stored by subtracting, from an initial deadline included in the data packet stored, the upstream-side communication time calculated, the downstream-side communication time calculated, and the retention time counted; and
transmitting, with a highest priority, a data packet corresponding to a minimum value of the deadline calculated among data packets stored, to the reception apparatus.

14. The communication control method according to claim 13, further comprising:
acquiring a downstream-side communication information packet transmitted from the reception apparatus and including the downstream-side communication time of a past and the capacity value;
learning the downstream-side communication time function based on the downstream-side communication information packet acquired;
measuring a total capacity value of the data packet stored in the relay apparatus;
detecting an abnormality of the relay apparatus by determining whether or not the total capacity value measured exceeds a reference total capacity value set in advance;
calculating an expiration period by using the total capacity value measured when an abnormality of the relay apparatus is detected;
generating an abnormality notification packet including the expiration period calculated as a n additional downstream-side communication time;
transmitting the abnormality notification packet generated to an upstream-side relay apparatus disposed on a communication path between the relay apparatus and the transmission apparatus;
detecting, by receiving another abnormality notification packet similar to the abnormality notification packet transmitted from a downstream-side relay apparatus disposed on the communication path between the relay apparatus and the reception apparatus, an abnormality of the downstream-side relay apparatus, and registering another additional downstream-side communication time included in the another abnormality notification packet and being similar to the additional downstream-side communication time; and
learning the downstream-side communication time function using the another additional downstream-side communication time registered;
wherein the downstream-side communication time is calculated using the downstream-side communication time function learned.

15. A communication control method, that controls communication by a relay apparatus that relays a data packet from a transmission apparatus to a reception apparatus, the communication control method comprising:
calculating a downstream-side communication time, which is a communication time on a communication path between the relay apparatus and the reception apparatus;
measuring a total capacity value of the data packet stored in the relay apparatus;
detecting an abnormality of the relay apparatus by determining whether or not the total capacity value measured exceeds a reference total capacity value set in advance; and
calculating an expiration period using the total capacity value measured when an abnormality of the relay apparatus is detected;
generating an abnormality notification packet including the expiration period calculated as a n additional downstream-side communication time; and
transmitting the abnormality notification packet generated, to an upstream-side relay apparatus disposed on a communication path between the relay apparatus and the transmission apparatus;
wherein when the downstream-side communication time is calculated, by receiving another abnormality notification packet similar to the abnormality notification packet from a downstream-side relay apparatus disposed on the communication path between the relay apparatus and the reception apparatus, an abnormality of the downstream-side relay apparatus is detected, and the downstream-side communication time is extended based on the additional downstream-side communication time included in the another abnormality notification packet.

16. The communication control method according to claim 13, wherein when learning the downstream-side communication time function,
creating a scatter diagram in which points, which indicate the downstream-side communication time and the capacity value for the individual downstream-side communication information packet, are plotted in a graph in which a X axis represents capacity value and a Y axis represents downstream-side communication time,
creating a regression line based on the scatter diagram created, and
learning the downstream-side communication time function based on the regression line created.

17. The communication control method according to claim 13; wherein the initial deadline is set by the transmission apparatus according to a packet type or the capacity value of the data packet.

18. The communication control method according to claim 13; wherein, when a new data packet is inputted to and stored, calculating and storing the deadline of the new data packet and
performing a recalculation of the deadline of an existing data packet stored.

19. The communication control method according to claim 18;
wherein a timer is reset to 0 when the new data packet is inputted and stored; and
wherein, the deadline of the existing data packet stored is recalculated by subtracting a timer count value immediately before the timer is reset to 0 from the deadline immediately before the recalculation.

20. The communication control method according to claim 18;
wherein, when the data packet is transmitted, the data packet transmitted and the deadline corresponding to the data packet transmitted are deleted.
